(19) United States
(12) Patent Application Publication
(10) Pub. No.: US 2014/0052941 A1
(43) Pub. Date: Feb. 20, 2014

(54) CALCULATION PROCESSING DEVICE AND CONTROL METHOD FOR CALCULATION PROCESSING DEVICE

(71) Applicant: FUJITSU LIMITED, Kawasaki-shi (JP)

(72) Inventors: Daisuke KARASHIMA, Hachiouji (JP); Shuji Yamamaura, Yokohama (JP); Naoya Ishimura, Tama (JP)

(73) Assignee: FUJITSU LIMITED, Kawasaki-shi (JP)

(21) Appl. No.: 13/901,654

(22) Filed: May 24, 2013

(30) Foreign Application Priority Data
Aug. 20, 2012 (JP) 2012-181522

(51) Int. Cl. G06F 12/00

(52) U.S. Cl. CPC G06F 12/00
USPC 711/154

(57) ABSTRACT

A device includes: a request-storage unit including entries configured to store requests and stopping issuance of a stored request when a flag is set based on an input configuration notification, in which the request-storage unit outputs a warning notification when the request stored in any of the entries has not been processed for more than a predetermined amount of time; a derived request-storage unit including derived entries configured to store derived requests derived from processing of requests stored in the request-storage unit; an arbitrating unit configured to arbitrate requests stored in the request-storage unit and derived requests stored in the derived request-storage unit, and to output the configuration notification based on the warning notification output from the request-storage unit; and a request-processing unit configured to process requests or derived requests arbitrated by the arbitrating unit, and to request-storage of derived requests derived by processing requests into the derived-storage unit.

### CROSS-REFERENCE TO RELATED APPLICATION

This application is based upon and claims the benefit of priority from the prior Japanese Patent Application No. 2012-181522 filed on Aug. 20, 2012, the entire contents of which are incorporated herein by reference.

### FIELD

The embodiment is related to a calculation processing device and a control method for a calculation processing device.

### BACKGROUND

When a calculation processing device, which is a central processing unit (CPU) core within a CPU functioning as a calculation processing unit, for example, sequentially sends access requests to a storage unit, the access requests are held in a request storage unit. The access request held in the request storage unit is selected in accordance with the order of priority and output to the storage device. After a certain amount of time has elapsed since the access request has been held in the request storage unit, the access request may be processed by inhibiting other access requests from being output to the storage device. When there are multiple access requests in which a certain amount of time has elapsed since being held in the request storage unit, the timing to process these access requests may be slightly altered between these access requests so that none of these access requests are inhibited (refer to Japanese Laid-open Patent Publication No. 5-081042, for example).

Also, when access requests come consecutively from one processor regarding a storage device shared between multiple processors, access requests are received from another processor, for example, by controlling the period to output a wait signal to the another processor (refer to Japanese Laid-open Patent Publication No. 2004-334361).

For example, for configurations in which a derived request based on a new request is output from the calculation processing unit is generated, for example, the calculation processing device includes a new request storage unit for storing new requests and a derived request storage unit for storing derived requests. When the new request held in the new request storage unit is not processed for a certain amount of time, and then is given priority and processed, access to the storage device by the derived request is inhibited. When the derived request is generated based on the new request given priority, the derived request storage unit may become full with derived requests. If the derived request storage unit becomes full, the new request that will generate the derived request is aborted. That is to say, when derived requests are inhibited in order to proceed with processing of new requests, this result in the trouble in processing the derived requests to become a bottleneck, processing of new requests ceases, and the calculation processing device may hang up.

### SUMMARY

According to an aspect of the embodiment, a device includes: a request-storage unit including entries configured to store requests and stopping issuance of a stored request when a flag is set based on an input configuration notification, in which the request-storage unit outputs a warning notification when the request stored in any of the entries has not been processed for more than a predetermined amount of time; a derived request-storage unit including derived entries configured to store derived requests derived from processing of requests stored in the request-storage unit; an arbitrating unit configured to arbitrate requests stored in the request-storage unit and derived requests stored in the derived request-storage unit, and to output the configuration notification based on the warning notification output from the request-storage unit; and a request-processing unit configured to process requests or derived requests arbitrated by the arbitrating unit, and to request-storage of derived requests derived by processing requests into the derived-storage unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing device and a calculation processing device according to an embodiment.

FIG. 2 is a diagram illustrating an example of an operation of the information processing device and the calculation processing device illustrated in FIG.

FIG. 3 is a diagram illustrating an example of an operation of the information processing device and the calculation processing device illustrated in FIG.

FIG. 4 is a diagram illustrating an example of an information processing device and a calculation processing device according to another embodiment.

FIG. 5 is a diagram illustrating an example of an information processing device and a calculation processing device according to another embodiment.

FIG. 6 is a diagram illustrating an example of ports MIP1, MIP2, PFP1, and PFP2 illustrated in FIG. 5.

FIG. 7 is a diagram illustrating an example of ports MOP1, MOP2, MIBP1, and MIBP2 illustrated in FIG. 5.

FIG. 8 is a diagram illustrating an example of an arbitrating unit illustrated in FIG. 5.

FIG. 9 is a diagram illustrating an example of an operation of the arbitrating unit illustrated in FIG. 8.

FIG. 10 is a diagram illustrating an example of an operation of the information processing device and the calculation processing device when an access request is supplied to the port MIP1 illustrated in FIG. 5.

FIG. 11 is a diagram illustrating an example of an operation of a step S10 illustrated in FIG. 10.

FIG. 12 is a diagram illustrating an example of an operation of the information processing device and the calculation processing device when an access request is supplied to the port MIBP1 illustrated in FIG. 5.

FIG. 13 is a diagram illustrating an example of an operation of a step S40 illustrated in FIG. 12.

FIG. 14 is a diagram illustrating an example of an operation of the information processing device and the calculation processing device illustrated in FIG. 5.

FIG. 15 is a diagram illustrating an example of an information processing device and a calculation processing device according to another embodiment.

FIG. 16 is a diagram illustrating an example of an arbitrating unit illustrated in FIG. 15.

FIG. 17 is a diagram illustrating an example of an operation of the information processing device and the calculation processing device illustrated in FIG. 15.

FIG. 18 is a diagram illustrating an example of an information processing device and a calculation processing device according to another embodiment.

FIG. 19 is a diagram illustrating an example of ports MIP1, MIP2, PFP1, and PFP2 illustrated in FIG. 18.

FIG. 20 is a diagram illustrating an example of ports MOP1, MOP2, MIBP1, and MIBP2 illustrated in FIG. 18.

FIG. 21 is a diagram illustrating an example of an operation of the information processing device and the calculation processing device illustrated in FIG. 18.

FIG. 22 is a diagram illustrating an example of an operation of the information processing device and the calculation processing device illustrated in FIG. 18.

FIG. 23 is a diagram illustrating another example of the ports MIP1, MIP2, PFP1, and PFP2 illustrated in FIG. 6.

### DESCRIPTION OF EMBODIMENTS

Hereinafter, the embodiments will be described with reference to the drawings.

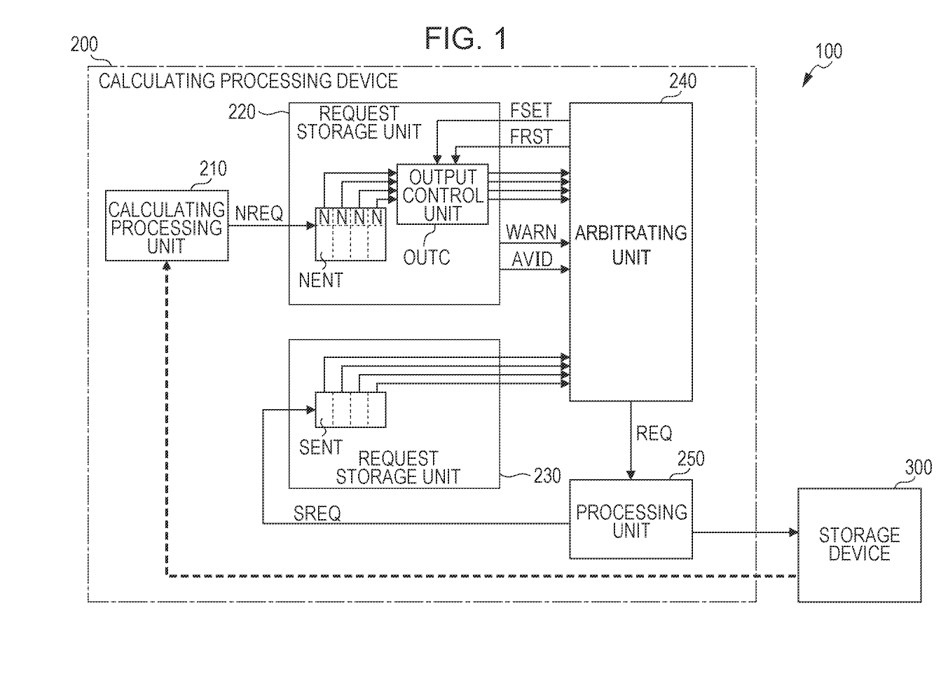

FIG. 1 illustrates an example of an information processing device 100 and a calculation processing device 200 according to an embodiment. The information processing device 100 includes the calculation processing device 200 and a recording device 300. The information processing device 100 may be, for example, a computer device such as a server or a personal computer, and the calculation processing device 200 may be a processor such as a CPU.

The recording device 300 may be, for example, memory, such as a dual inline memory module (DIMM) to which is installed multiple dynamic random access memory (DRAM) chips. The recording device 300 stores a program executed by a calculation processing unit 210 of the calculation processing device 200 and data processed by the calculation processing unit 210. Further, the recording device 300 may be formed as semiconductor memory chips or semiconductor memory cores.

The calculation processing device 200 and the recording device 300 may be installed on a printed circuit board for example. Further, the calculation processing device 200 may be a processor chip or a processor core. In this case, the calculation processing device 200 and the recording device 300 may be installed on one semiconductor chip.

The calculation processing device 200 includes the calculation processing unit 210, request storage units 220 and 230, an arbitrating unit 240, and a request processing unit 250. The calculation processing unit 210 is a CPU core, for example, and outputs access requests NREQ to the recording device 300. The access requests NREQ includes at least any of input and output requests of data handled by the calculation processing unit 210 such as load instructions and store instructions, and program prefetch requests executed by the calculation processing unit 210.

The request storage unit 220 includes at least one entry NENT for storing the access requests NREQ output by the calculation processing unit 210, and an output control unit OUTC for controlling output of access requests NREQ stored in the entry NENT to the arbitrating unit 240. The entry NENT is an example of a request entry.

Each entry NENT includes, for example, a flag N for differentiating between an access requests NREQ stored before receiving a configuration notification FSET and access requests NREQ stored after receiving the configuration notification FSET. When the request storage unit 220 stores the access request NREQ in the entry NENT after receiving the configuration notification FSET, the request storage unit 220 sets the flag N. Further, the flag N may be provisioned external to the entry NENT corresponding to each entry NENT.

When the configuration notification FSET is received from the arbitrating unit 240, the output control unit OUTC, for example, inhibits the output of the access request NREQ stored in the entry NENT to which the flag N has been set. When a release notification FRST is received from the arbitrating unit 240, the output control unit OUTC outputs the access request NREQ stored in the entry NENT to the arbitrating unit 240 regardless of the state of the flag N.

Further, the configuration notification FSET and the release notification FRST may be transferred to the output control unit OUTC from the arbitrating unit 240, for example, using a logic level over one signal line. In this case, a high level signal (or leading edge) represents the configuration notification FSET, for example, and a low level signal (or trailing edge) represents the release notification FRST.

Also, when the access request NREQ still has not been processed after a predetermined time has passed is stored in any entry NENT, the request storage unit 220 outputs a warning notification WARN to the arbitrating unit 240. Further, when the request storage unit 220 determines that the access request NREQ that still has not been processed after a predetermined time has passed from being stored in the entry NENT, has been processed by the request processing unit 250, the request storage unit 220 outputs a bypass notification AVID to the arbitrating unit 240.

The request storing unit 230 includes at least one entry SENT for storing access requests SREQ. The request storing unit 230 is an example of a derived request storage unit, and the entry SENT is an example of the derived request entry. The access request SREQ is an example of a derived request generated when access to the recording device 300 becomes important due to the processing of the access request NREQ stored in the request storage unit 220. Further, FIG. 1 illustrates an example in which the request storage unit 220 and 230 has four units of entry NENT and entry SENT, respectively, but the unit number of entry NENT and entry SENT is not limited to four.

The arbitrating unit 240 arbitrates the access request NREQ stored in the request storage unit 220 and the access request SREQ stored in the request storing unit 230, and selects an access request REQ to be output to the recording device 300. For example, the arbitrating unit 240 uses a method such as a round robin method to sequentially select the access requests NREQ and access requests SREQ stored in the request storage unit 220 and the request storing unit 230, respectively. Also, the arbitrating unit 240 outputs the selected access request NREQ (or access request SREQ) to the request processing unit 250.

Further, according to FIG. 1, the request storage unit 220 outputs multiple access requests NREQ stored in the entry NENT to the arbitrating unit 240, and the request storing unit 230 outputs multiple access requests SREQ stored in the entry SENT to the arbitrating unit 240. However, the request storage unit 220 may sequentially select the entry NENT, and then may output the access request NREQ stored in the selected entry NENT to the arbitrating unit 240. The request storage unit 230 may sequentially select the entry SENT, and then may output the access request SREQ stored in the selected entry SENT to the arbitrating unit 240.

Also, the arbitrating unit 240 outputs the configuration notification FSET to the request storage unit 220 on the basis of the warning notification WARN output from the request storage unit 220. Further, the arbitrating unit 240 outputs the release notification FRST to the request storage unit 220 on the basis of the bypass notification AVID output from the request storage unit 220.

The request processing unit 250 outputs the access request REQ output from the arbitrating unit 240 to the recording device 300. For example, the recording device 300 executes the readout operation on the basis of the access request REQ, and outputs the data read from a memory cell to the calculation processing unit 210. According to FIG. 1 through FIG. 23, a heavy, dashed line represents a data line in which the data is transferred.

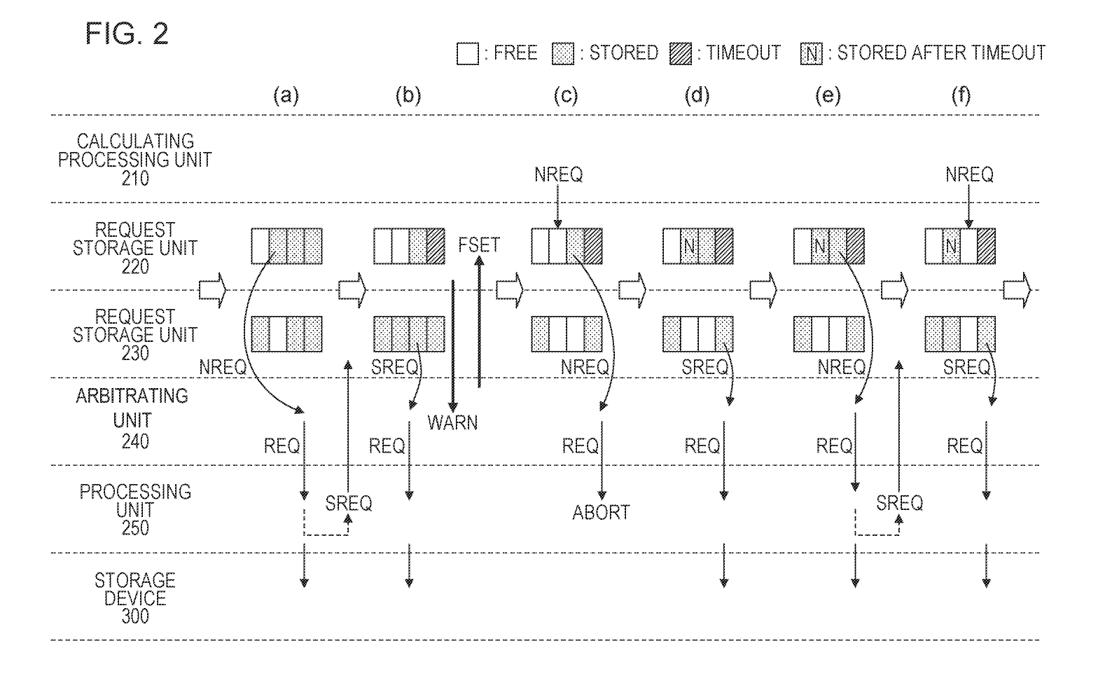

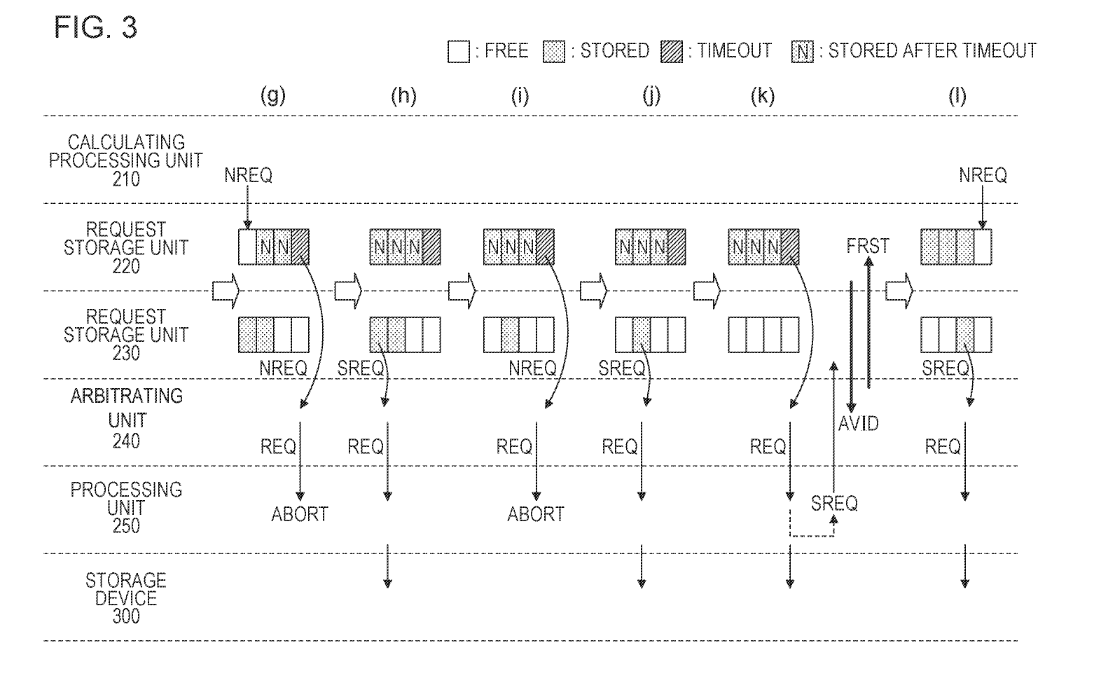

FIG. 2 and FIG. 3 illustrate examples of an operation of the information processing device 100 and the calculation processing device 200 illustrated in FIG. 1. That is to say, FIG. 2 and FIG. 3 illustrate examples of a control method regarding the information processing device 100 and the calculation processing device 200. FIG. 3 illustrates the continued operation of that illustrated in FIG. 2. Free units of entry NENT (or entry SENT) in FIG. 2 and FIG. 3 represent an empty state in which the access request NREQ (or access request SREQ) is not being stored. Shaded units of entry NENT (or entry SENT) represent a state in which the access request NREQ (or access request SREQ) is being stored.

The units of entry NENT with diagonal lines represent a state in which a predetermined time has passed since the access request NREQ has been received. When the state as represented by the entry NENT with diagonal lines continues, the calculation processing unit 210 is no longer able to receive data corresponding to the access request NREQ, and may hang up. Shaded units of the entry NENT with an added “N” represent a state in which an access request NREQ newly supplied from the calculation processing unit 210 is stored after receiving the configuration notification FSET from the arbitrating unit 240. The shaded units of entry NENT with the added “N” are then updated to shaded units of entry NENT without the added “N” on the basis of the release notification FRST.

Regarding an initial state (a), the request storage unit 220 stores the access request NREQ in three units of the entry NENT, and the request storing unit 230 stores the access request SREQ in three units of the entry SENT. The arbitrating unit 240 selects an access request NREQ stored by the request storage unit 220, and outputs this to the request processing unit 250 as the access request REQ. The request processing unit 250 executes processing to access the recording device 300 illustrated in FIG. 1 on the basis of the access request REQ. Also, the request processing unit 250 determines that access to the recording device 300 has become more important due to access processing based on the access request NREQ. The request processing unit 250 outputs the access request SREQ derived based on the access request NREQ to a free entry SENT in the request storing unit 230.

Regarding a state (b), the arbitrating unit 240 selects an access request SREQ stored in the request storing unit 230, and outputs this to the request processing unit 250 as the access request REQ. The request processing unit 250 executes processing to access the recording device 300 illustrated in FIG. 1 on the basis of the access request REQ. Also, regarding the state (b), the request storage unit 220 detects for the existence of access requests NREQ that still have not been processed after a predetermined time has passed among the access requests NREQ stored in the entry NENT (entry NENT with diagonal lines), and outputs the warning notification WARN to the arbitrating unit 240. The arbitrating unit 240 receives the warning notification WARN, and outputs the configuration notification FSET to the request storage unit 220. Also, the arbitrating unit 240 selects an access request SREQ stored in the request storing unit 230, and outputs this to the request processing unit 250 as the access request REQ. The request processing unit 250 executes processing to access the recording device 300 on the basis of the access request REQ.

Regarding a state (c), the calculation processing unit 210 stores the access request NREQ in a free entry NENT in the request storage unit 220. The request storage unit 220 sets the flag N for the entry NENT storing the access request NREQ after the configuration notification FSET has been received (entry NENT with the “N” added at a state (d)). That is to say, the access request NREQ after the configuration notification FSET has been received is stored after being differentiated from the access request NREQ before the configuration notification FSET has been received by the flag N. The request storage unit 220 inhibits sending to the arbitrating unit 240 the access request NREQ stored in the entry NENT which has the flag N set.

The arbitrating unit 240 selects the next access request NREQ stored in the request storage unit 220, and outputs this to the request processing unit 250 as the access request REQ. The request processing unit 250 aborts the access request NREQ, for example, due to the occurrence of database competition as a result of the processing of the access request SREQ.

Regarding a state (d), similar to the state (b), the arbitrating unit 240 selects an access request SREQ stored in the request storing unit 230, and outputs this to the request processing unit 250 as the access request REQ. The request processing unit 250 executes processing to access the recording device 300 on the basis of the access request REQ.

Regarding a state (e), similar to the state (a), the arbitrating unit 240 selects an access request NREQ stored in the request storage unit 220, and the request processing unit 250 accesses the recording device 300 on the basis of the access request NREQ. Also, the request processing unit 250 outputs the access request SREQ derived based on the access request NREQ to a free entry SENT in the request storing unit 230.

Regarding a state (f), the calculation processing unit 210 stores the access request NREQ in a free entry NENT in the request storage unit 220. Also, similar to the previously described state (d), the arbitrating unit 240 selects an access request SREQ stored in the request storing unit 230, and the request processing unit 250 executes processing to access the recording device 300 on the basis of the access request SREQ.

Next, regarding a state (g) illustrated in FIG. 3, the calculation processing unit 210 stores the access request NREQ in a free entry NENT in the request storage unit 220. Also, at the state (g), similar to the state (c), the arbitrating unit 240 selects an access request NREQ stored in the request storage unit 220. However, the request processing unit 250 aborts the access request NREQ due to the occurrence of database competition as a result of the processing of the access request SREQ, for example. Further, regarding states (g) and (h), with the exception of one entry NENT, the request storage unit 220 stores the access request NREQ after the configuration notification FSET has been received. The request storage unit 220 inhibits the sending of access requests NREQ to the arbitrating unit 240, and so the access requests NREQ which are selectable by the arbitrating unit 240 become limited. There are cases, for example, in which access requests NREQ that have a higher potential to be aborted in comparison to other access requests NREQ are continually selected.

Regarding the state (h), similar to the state (d), the arbitrating unit 240 selects an access request SREQ stored in the request storing unit 230, and the request processing unit 250 executes processing to access the recording device 300 on the basis of the access request SREQ.

Next, regarding a state (i), similar to the state (g), the arbitrating unit 240 selects an access request NREQ stored in the request storage unit 220, but the request processing unit 250 aborts the access request NREQ. Next, regarding a state (j), similar to the state (d), the arbitrating unit 240 selects an access request SREQ stored in the request storing unit 230, and the request processing unit 250 executes processing to access the recording device 300 on the basis of the access request SREQ. As a result of this processing, the processing of all the access requests SREQ stored in the request storing unit 230 is finished.

In this way, by inhibiting the sending of the access request NREQ stored in the entry NENT after the configuration notification FSET to the arbitrating unit 240, the frequency of access requests SREQ, which are derived requests, occurring may be reduced as compared to the related art. As a result, the occurrence of derived requests not processed may be reduced, and the potential for the calculation processing device 200 to hang up may be decreased as compared to the related art.

Regarding a state (k), similar to the state (e), the arbitrating unit 240 selects the access request NREQ stored in the entry NENT for which the flag N has been reset. The request processing unit 250 accesses the recording device 300 on the basis of the access request NREQ, and outputs the access request SREQ derived on the basis of the access request NREQ to a free entry SENT. The request storage unit 220 outputs the bypass notification AVID to the arbitrating unit 240 on the basis of that the access request NREQ stored before the configuration notification FSET is now gone. The arbitrating unit 240 receives the bypass notification AVID, and outputs the release notification FRST to the request storage unit 220.

Regarding a state (I), the calculation processing unit 210 stores the access request NREQ in a free entry NENT in the request storage unit 220. The request storage unit 220 resets the flag N after receiving the release notification FRST. As a result, the access request NREQ is stored in the entry NENT without differentiation regarding age during the period until the next configuration notification FSET is received. The arbitrating unit 240 selects an access request SREQ stored in the request storing unit 230, and executes processing to access the recording device 300 on the basis of the access request SREQ.

Thus, according the present embodiment, when there are access requests NREQ that still has not been processed after a predetermined time has passed, though the output of new access requests NREQ to be stored is inhibited, there is no restriction on the selection of access requests SREQ stored in the request storing unit 230. As a result, older access requests NREQ may be processed at a higher priority as compared with newer access requests NREQ. Also, the frequency of access request SREQ, which are derived requests, occurring may be lowered as compared to the related art, and access requests SREQ are less likely to accumulate in the entry SENT.

Therefore, failures in the processing of the access requests SREQ, which are derived requests, may be suppressed, and the delay of access request NREQ processing may be avoided. As a result, the probability of the calculation processing unit 210 hanging up due to the access requests NREQ not being processed may be decreased as compared to the related art, and the subsequent drop in performance of the information processing device 100 and the calculation processing device 200 may be suppressed.

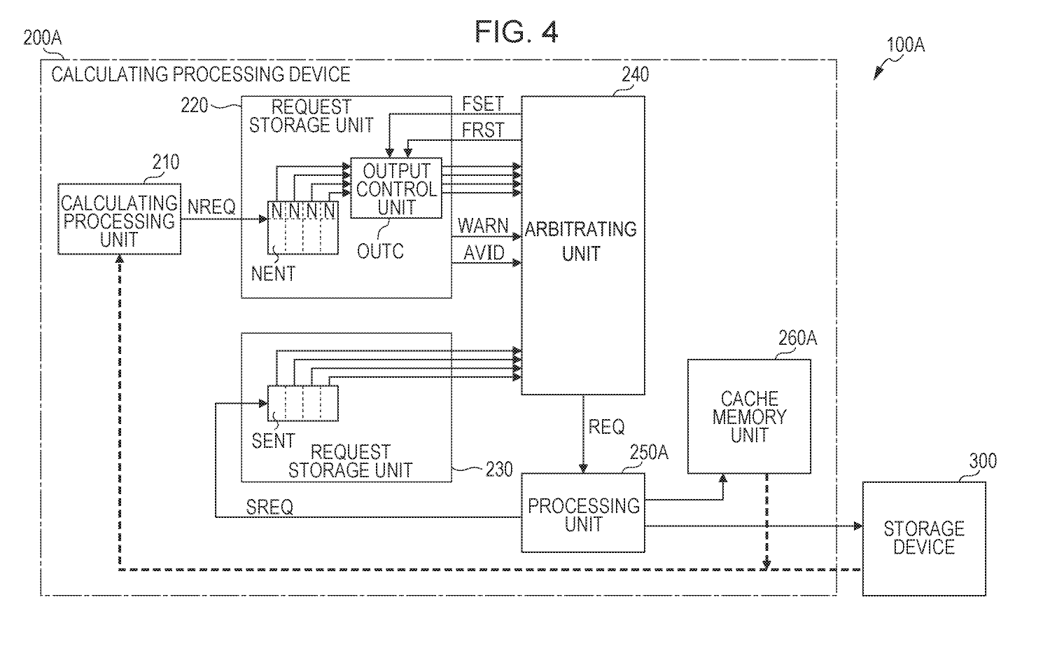

FIG. 4 illustrates an example of an information processing device 100A and a calculation processing device 200A according to another embodiment. Elements that are the same as that in FIG. 1 have the same reference numerals, and their detailed descriptions have also been omitted. According to the present embodiment, the calculation processing device 200A includes a request processing unit 250A in place of the request processing unit 250 illustrated in FIG. 1. Also, the calculation processing device 200A includes a cache memory 260A in addition to the elements illustrated in FIG. 1. Other configurations of the calculation processing device 200A are the same as that of FIG. 1.

In addition to the functionality of the request processing unit 250 illustrated in FIG. 1, the request processing unit 250A checks whether or not data corresponding to the access request REQ output from the arbitrating unit 240 is stored in the cache memory 260A. That is to say, the request processing unit 250A includes the functionality of a control unit for controlling access to the cache memory 260A. For example, when the data corresponding to the access request REQ is stored in the cache memory 260A (cache hit), the request processing unit 250A does not output the access request REQ to the recording device 300, and reads out the data from the cache memory 260A. The data read out from the cache memory 260A is output to a calculation processing unit 210A.

In contrast, when the data corresponding to the access request REQ is not stored in the cache memory 260A (cache miss), the request processing unit 250A outputs the access request REQ to the recording device 300. Also, the data read out from the recording device 300 is output to the calculation processing unit 210A.

The access request NREQ is the access request corresponding to the cache memory 260A, for example, and the access request SREQ is the access request output to the recording device 300 when a cache miss occurs for the access request NREQ. The operation of the information processing device 100A and the calculation processing device 200A illustrated in FIG. 4 is similar to the operation of that in FIG. 2 and FIG. 3 with the exception of the following operation. According to the present embodiment, when a cache hit is determined, the access request NREQ is output to the cache memory 260A, and when a cache miss is determined, the access request SREQ is output to the recording device 300 instead of the access request NREQ.

Thus, according to the present embodiment, similar to the embodiment as illustrated in FIG. 1 through FIG. 3, failures in the processing of the access requests SREQ, which are the derived requests, may be resolved, and the delay of access request NREQ processing may be avoided. As a result, the probability of the calculation processing unit 210 hanging up due to older access requests NREQ not being processed may be decreased as compared to the related art, and the subsequent drop in performance of the information processing device 100A and the calculation processing device 200A may be suppressed.

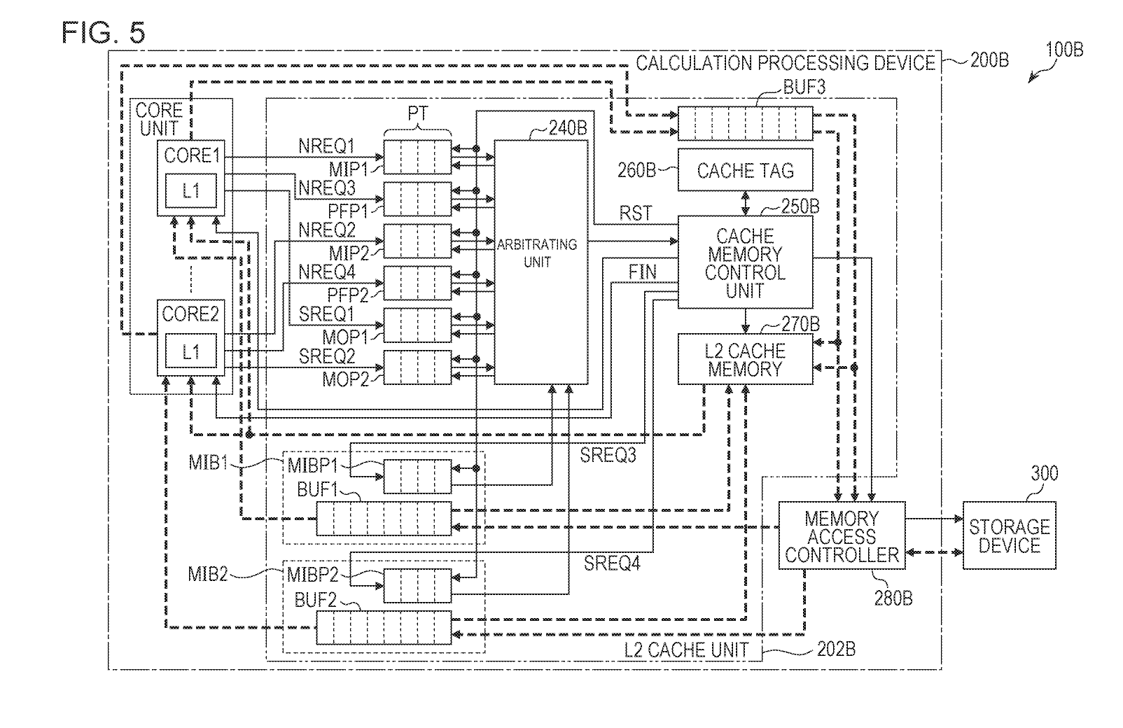

FIG. 5 illustrates an example of an information processing device 100B and a calculation processing device 200B according to another embodiment. Elements that are the same as that in FIG. 1 and FIG. 4 have the same reference numerals, and their detailed descriptions have also been omitted.

The information processing device 100B includes the calculation processing device 200B and the recording device 300. The information processing device 100B may be, for example, a computer device such as a server or a personal computer, and the calculation processing device 200B may be a processor such as a CPU.

The calculation processing device 200B includes multiple core units CORE (CORE1 and CORE2), ports PT (MIP1, PFP1, MIP2, PFP2, MOP1, MOP2, MIBP1, and MIBP2), an arbitrating unit 240B, a cache memory control unit 250B, a cache tag unit 260B, an L2 cache memory 270B, a memory access controller 280B, and data buffers BUF1, BUF2, and BUF3.

FIG. 5 illustrates an L2 cache unit 202B, which is the region enclosed by the alternating long and short dashed line. That is to say, the L2 cache unit 202B includes the ports PT, the arbitrating unit 240B, the cache memory control unit 250B, the cache tag unit 260B, the L2 cache memory 270B, the memory access controller 280B, and the data buffers BUF1, BUF2, and BUF3.

Each core unit CORE is, for example, a CPU core including an L1 cache unit illustrated by the reference number L1. The L1 cache unit includes an L1 cache memory and a memory control unit to control access to the L1 cache memory. The core units CORE are an example of a calculation processing unit.

The core unit CORE1 outputs an access request NREQ1 to the port MIP1, outputs an access request NREQ3 to the port PFP1, and outputs an access request SREQ1 to the port MOP1. The core unit CORE2 outputs an access request NREQ2 to the port MIP2, an access request NREQ4 to the port PFP2, and an access request SREQ2 to the port MOP2.

The access request NREQ1 and NREQ2 are, for example, input and output requests for data handled by the core units CORE such as load instructions and store instructions. The load instruction instructs data read out from the L1 cache memory, the L2 cache memory 270B, or the recording device 300 to be stored in a register in the core units CORE. The L1 cache unit outputs the load instruction to the L2 cache unit 202B when there is no data corresponding to the load instruction stored in the L1 cache memory (cache miss).

The store instruction instructs the data processed by the core units CORE to be stored in the L1 cache memory. The L1 cache unit outputs the store instruction to the L2 cache unit 202B when a cache line including a region of data corresponding to the store instruction is not allocated in the L1 cache memory (cache miss).

Store instructions are instructions to store the data which has been processed by the core unit CORE in the L1 cache memory. In the event that the cache line including a region of the data corresponding to the store instruction is not secured in the L1 cache memory (cache miss), the L1 cache memory outputs the store instruction to the L2 cache unit 202B.

The L2 cache unit 202B that has received the store instruction from the L1 cache unit reads the data corresponding to the store instruction (cache line) from the L2 cache memory 270B or the recording device 300, and outputs the data read out to the L1 cache unit. In this way, the load instruction and the store instruction output to the L2 cache unit 202B by the core units CORE are instructions for reading out data from the L2 cache memory 270B and the recording device 300.

The access request NREQ3 and NREQ4 are, for example, prefetch instructions to preemptively read a program executed by each core unit CORE from the recording device 300 into the L2 cache memory 270B. Further, as will be described later, when there is a cache miss in the L2 cache memory 270B, access to the recording device 300 is executed by the access request SREQ3 and SREQ4 generated as derivations of access request NREQ1 through NREQ4.

The access request SREQ1 and SREQ2, for example, write back instructions that transfer the data stored in the L1 cache memory to the L2 cache memory 270B and the recording device 300, to free a region of L1 cache memory. The core units CORE output the access request SREQ1 and SREQ2 when there is no region in the L1 cache memory to store the data transferred to the core units CORE by the processing of the access request NREQ1 through NREQ4. That is to say, the access request SREQ1 and SREQ2 are derived access requests generated as derivations of the access request NREQ1 through NREQ4.

The access request SREQ3 and access request SREQ4 are, for example, generated by the request processing unit cache memory control unit 250B when there is a cache miss in the L2 cache memory 270B based on the access request NREQ1 through NREQ4. That is to say, the access request SREQ3 and SREQ4 are derived access requests generated as derivations of the access request NREQ1 through NREQ4.

The cache memory control unit 250B accesses the recording device 300 through the memory access controller 280B on the basis of the access request SREQ3 and SREQ4 from the arbitrating unit 240B. The data read out from the recording device 300 on the basis of the access request SREQ3 is stored in the data buffer BUF1 corresponding to the move in buffer port (MIBP) 1. The data read out from the recording device 300 on the basis of the access request SREQ4 is stored in the buffer BUF2 corresponding to the port MIBP2.

For the following description, the access requests NREQ1 through NREQ4 will be referred to the access request NREQ, and the access requests SREQ1 through SREQ4 will be referred to as the access request SREQ. Also, the access requests NREQ1 through NREQ4 and the access requests SREQ1 through SREQ4 will be referred to the access request REQ.

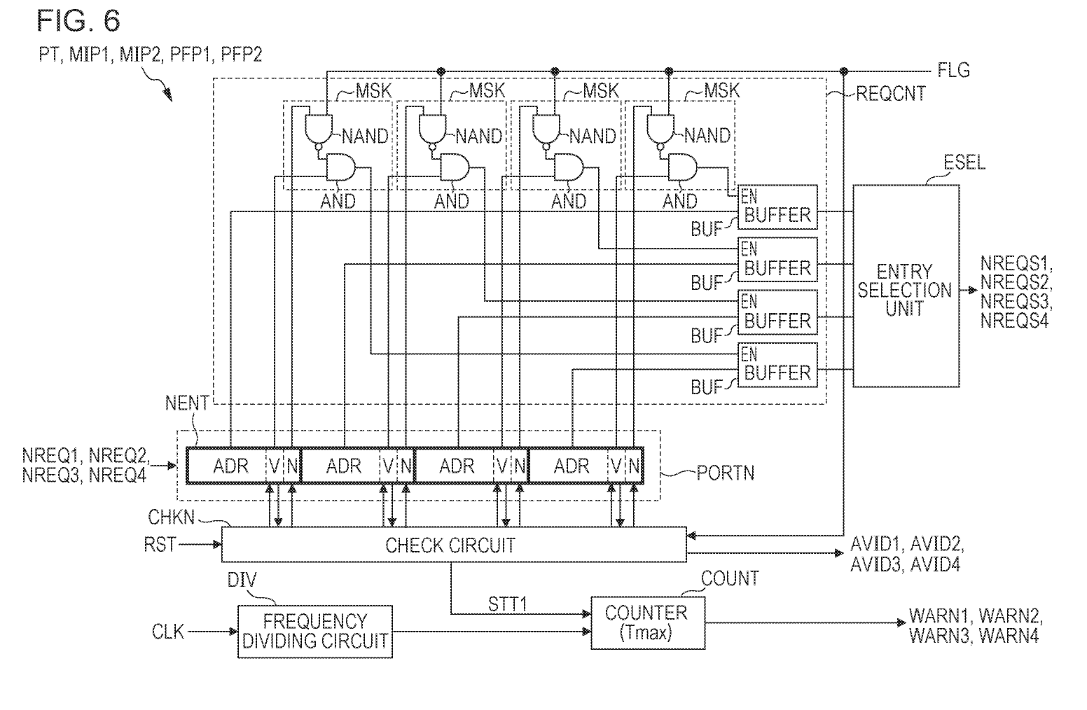

The port move in port (MIP) 1 includes multiple units of entry NENT (FIG. 6) for storing the access request NREQ1 from the core unit CORE1. The port pre fetch port (PFP) 1 includes multiple units of entry NENT for storing the access request NREQ2 from the core unit CORE1. The port MIP2 includes multiple units of entry NENT for storing the access request NREQ2 from the core unit CORE2. The port MIP2 includes multiple units of entry NENT for storing the access request NREQ4 from the core unit CORE2. Ports MIP1, PFP1, MIP2, and PFP2 are examples of the request storage unit. Examples of ports MIP1, PFP1, MIP2, and PFP2 are illustrated in FIG. 6.

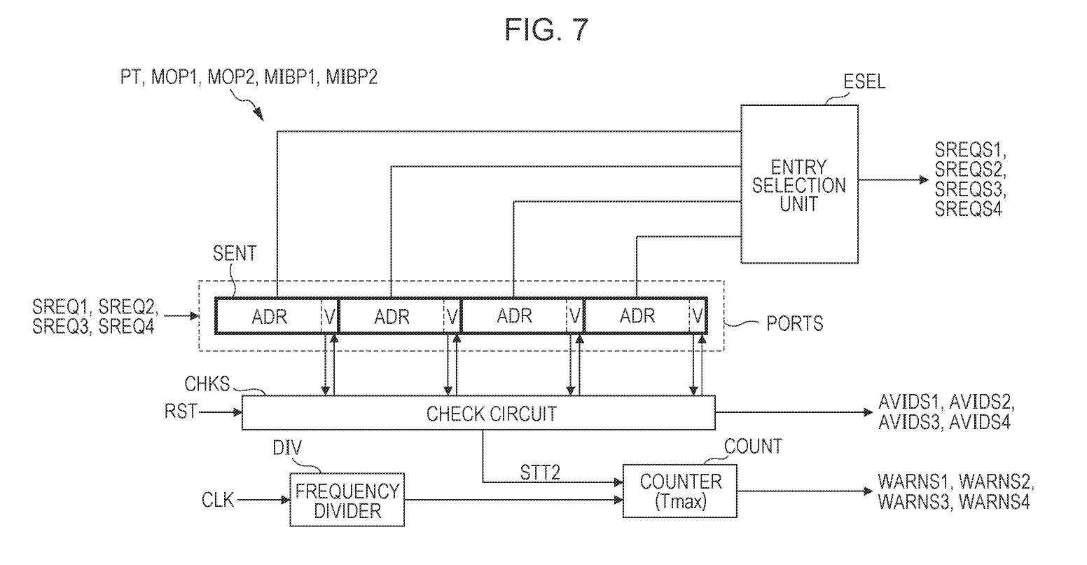

The port move out port (MOP) 1 includes multiple units of entry SENT (FIG. 7) for storing the access request SREQ1 from the core unit CORE1. The port MOP2 includes multiple units of entry SENT for storing the access request SREQ2 from the core unit CORE2. The port move in buffer port (MIBP) 1 includes multiple units of entry SENT for storing the access request SREQ3 output from the cache memory control unit 250B. The port MIBP2 includes multiple units of entry SENT for storing the access request SREQ4 output from the cache memory control unit 250B. Ports MOP1, MOP2, MIBP1, and MIBP2 are examples of the derived request storage unit.

The data stored in data buffers BUF1 and BUF2 are output to and stored in the L2 cache memory 270B and the L1 cache memory. However, when access request SREQ3 and SREQ4 are derived based on the access request NREQ3 and NREQ4, which are prefetch instructions, the data stored in the data buffer BUF1 (or BUF2) is output to the L2 cache memory 270B, but this is not stored in the L1 cache memory. Further, there are cases when the port MIB1 refers to a combination of the port MIBP1 and the data buffer BUF1, and as well there are cases when the port MIB2 refers to a combination of the port MIBP2 and the data buffer BUF2.

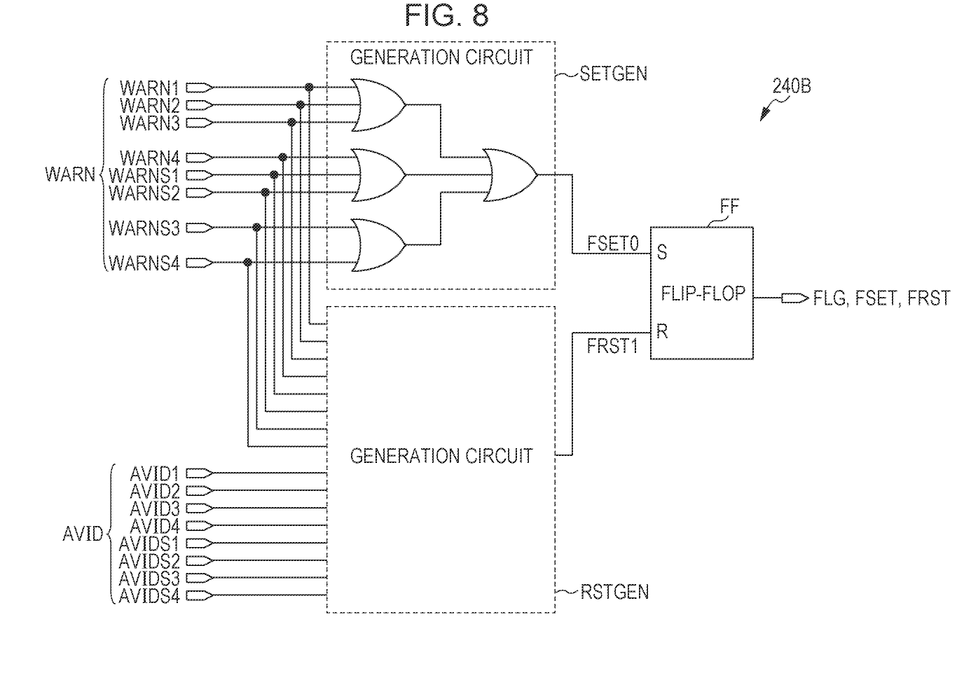

The arbitrating unit 240B arbitrates the access request REQ stored in any of the ports PT, and outputs these to the L2 cache memory 270B. For example, the arbitrating unit 240B uses a method such as the round robin method to sequentially select the access request REQ stored in ports MIP1, PFP1, MIP2, PFP2, MOP1, MOP3, MIPB1, and MIPB2. Also, the arbitrating unit 240B outputs to the ports MIP1, PFP1, MIP2, and PFP2 the configuration notification FSET (FIG. 8) based on the warning notification WARN (FIG. 6) and WARNS (FIG. 7) from each port PT. The arbitrating unit 240B outputs to the ports MIP1, PFP1, MIP2, and PFP2 the release notification FRST (FIG. 8) based on the bypass notification AVID (FIG. 6) and AVIDS (FIG. 7) from each port PT. For example, the configuration notification FSET is represented by the high level of a flag signal FLG (FIG. 8), and the release notification FRST is represented as the low level of the flag signal FLG. An example of the arbitrating unit 240B is illustrated in FIG. 8.

The cache memory control unit 250B outputs address information included in the access request NREQ arbitrated by the arbitrating unit 240B to the cache tag unit 260B. The cache memory control unit 250B determines cache hits and cache misses regarding the L2 cache memory 270B on the basis of information read out from the cache tag unit 260B. When a cache hit is determined, the cache memory control unit 250B reads out the data from the L2 cache memory 270B, and outputs the read out data to the core unit CORE which has issued the access request NREQ. When a cache miss of the access request NREQ is determined, the cache memory control unit 250B outputs the access request to the memory access controller 280B.

Also, the cache memory control unit 250B outputs to the cache tag unit 260B the address information included in the access request SREQ1 and SREQ2 (write back instruction) arbitrated by the arbitrating unit 240B, and determines cache hits and cache misses regarding the L2 cache memory 270B. When a cache hit is determined, the cache memory control unit 250B outputs from the core unit CORE corresponding to the L2 cache memory 270B, and writes the data stored the data buffer BUF3 into the L2 cache memory 270B. When a cache miss is determined, the cache memory control unit 250B registers the address information included in the access request SREQ1 and SREQ2 and secures a new cache line. Also, the cache memory control unit 250B writes the data stored in the data buffer BUF3 into the allocated cache line. Further, the cache memory control unit 250B may output to the memory access controller 280B the address information included in the access request SREQ1 and SREQ2, and may write the data stored in the data buffer BUF3 into the recording device 300.

The cache memory control unit 250B outputs to the memory access controller 280B the address information included in the access request SREQ3 arbitrated by the arbitrating unit 240B. The memory access controller 280B access the recording device 300 on the basis of the access request SREQ3, and writes the data read out from the recording device 300 into the data buffer BUF1. The cache memory control unit 250B outputs to the memory access controller 280B the address information included in the access request SREQ4 arbitrated by the arbitrating unit 240B. The memory access controller 280B accesses the recording device 300 on the basis of the access request SREQ4, and writes the data read out from the recording device 300 into the data buffer BUF2.

Further, when the cache memory control unit 250B transfers data from the L2 cache memory 270B or the data buffers BUF1 and BUF2 to the core units CORE, the cache memory control unit 250B outputs a completion signal FIN representing a completion response to the access request REQ to the core unit CORE which has output the access request REQ. Also, when the cache memory control unit 250B receives both the access request NREQ and SREQ, the cache memory control unit 250B outputs a reset signal RST to the ports PT which has output the access request NREQ and SREQ. The ports PT that received the reset signal RST disable the corresponding access request NREQ and SREQ.

The reset signal RST corresponding to the access request NREQ is output on the basis of access to the L2 cache memory 270B in the event of a cache hit, for example, and is also output on the basis of the output of the access request SREQ, which is the derived instruction, in the event of a cache miss. The reset signal RST corresponding to the access request SREQ is output on the basis of the output of the access request sent from the cache memory control unit 250B to the memory access controller 280B.

The memory access controller 280B outputs to the recording device 300 an access signal (write request) executing an operation to write to the recording device 300 on the basis of the access request SREQ1 and SREQ2 from the cache memory control unit 250B. The memory access controller 280B outputs to the recording device 300 an access signal (readout request) executing an operation to read out from the recording device 300 on the basis of the access request SREQ3 and SREQ4 from the cache memory control unit 250B.

Further, the memory access controller 280B may be arranged externally from the calculation processing device 200B. Also, when the cache memory control unit 250B includes functionality to control access to the recording device 300, the recording device 300 may connect directly to the cache memory control unit 250B without going through the memory access controller 2808. In this case, the calculation processing device 200B may have no memory access controller 280B. Similarly with the following embodiments, the memory access controller 280B may be arranged externally from the calculation processing device, and does not have to reside within the information processing device.

FIG. 6 illustrates an example of the ports MIP1, MIP2, PFP1, and PFP2. The ports MIP1, MIP2, PFP1, and PFP2 have the same or similar configuration, and so only the port MIP1 will be described here. The port MIP1 includes a port unit PORTN, an issuance control unit REQCNT, an entry selection unit ESEL, a check circuit CHKN, a frequency dividing circuit DIV, and a counter COUNT.

As illustrated in FIG. 6, the port unit PORTN includes, for example, four units of the entry NENT for storing the access request NREQ1. Further, the unit number of the entry NENT is not limited to four. Each entry NENT includes an address region ADR for storing addresses representing storage regions of the recording device 300, a flag V, and a flag N. Each address region may be 32 bits in length, for example, each flag V is one bit, and each flag N is one bit.

The flag V represents whether an address stored in the address region ADR is valid or invalid. That is to say, the address for a valid access request NREQ1 is stored in the address region ADR of an entry NENT for which the flag V is set. The arbitrating unit 240B illustrated in FIG. 5 selects any entry NENT for which the flag V is set. The flag N is set, for example, corresponding to a newly received access request NREQ1 during the high level period of the flag signal FLG.

The issuance control unit REQCNT includes a mask circuit MSK corresponding to each entry NENT and a buffer BUF. When the flag N is set to a high level at a state in which the flag signal FLG from the arbitrating unit 240B is at a high level, the mask circuit MSK sets an enable terminal EN in the buffer BUF to a low level regardless of the level of the corresponding flag V. Each mask circuit MSK has a NAND circuit and an AND circuit. When the flag signal FLG is at a low level or the flag N is reset to a low level, the mask circuit MSK sets the level of the corresponding flag V to the enable terminal EN in the buffer BUF.

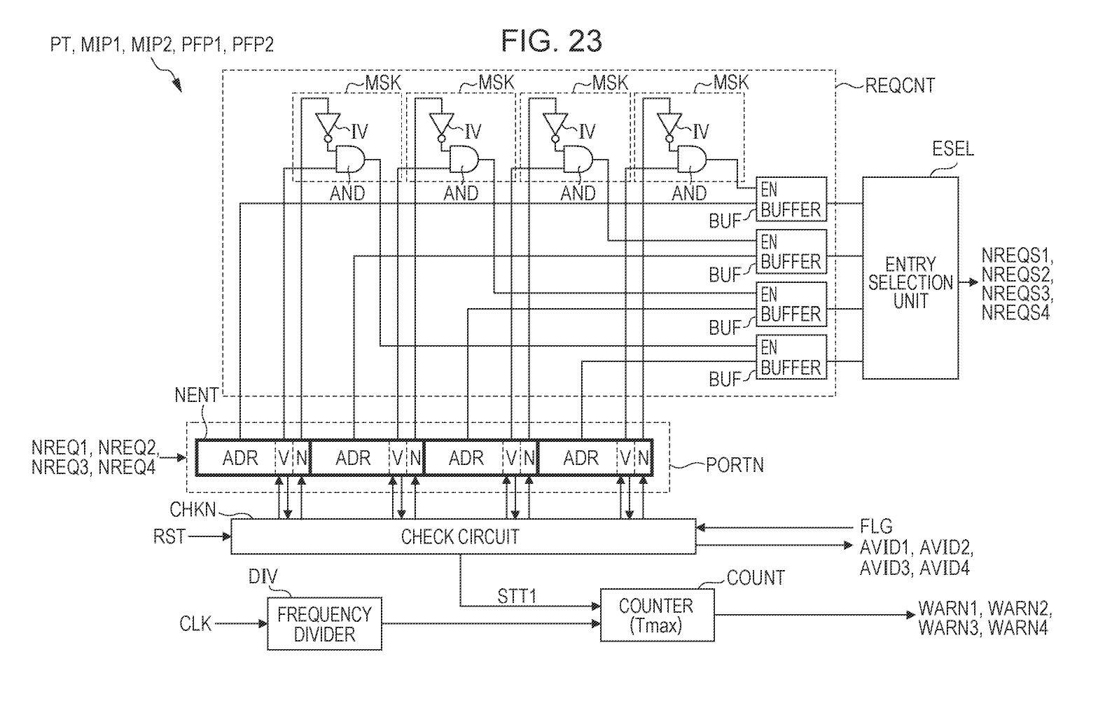

Further, when the flag N is reset during a period in which the flag signal FLG is at a low level, as illustrated in FIG. 23, each mask circuit MSK may invert the logic of the flag N, and include an inverter IV in place of a NAND circuit for outputting the inverted logic into input of an AND circuit. In this case, the mask circuit MSK may control the enable terminal EN in the buffer BUF without receiving the flag signal FLG.

The buffer BUF outputs the address stored in the address region ADR to an entry selection unit ESEL during a period in which the enable terminal EN receives a high level. The buffer BUF prohibits output of the address to the entry selection unit ESEL during a period in which the enable terminal EN receives a low level.

That is to say, the issuance control unit REQCNT resets the flag N during a period in which the flag signal FLG is at a high level, and outputs the address of the entry NENT for which the flag V is set to the entry selection unit ESEL. Also, the issuance control unit REQCNT inhibits the output of the entry NENT address for which the flag N or flag V is set to the entry selection unit ESEL during a period in which the flag signal FLG is at a high level. Further, the issuance control unit REQCNT outputs the address of the entry NENT for which the flag V is set to the entry selection unit ESEL regardless of the level of the flag N during a period in which the flag signal FLG is at a low level.

The entry selection unit ESEL sequentially selects addresses from all buffers BUF using a method such as a round robin method, for example, and outputs the selected address to the arbitrating unit 240B as an access request NREQS1. Further, the entry selection unit ESEL in the port MIP2 outputs an access request NREQS2 to the arbitrating unit 240B. The entry selection unit ESEL in the port PFP1 outputs an access request NREQS3 to the arbitrating unit 240B. The entry selection unit ESEL in the port PFP2 outputs an access request NREQ4 to the arbitrating unit 240B.

The check circuit CHKN sequentially selects the entry NENT for which the flag V is to be checked using a method such a round robin method, for example. When the check circuit CHKN detects that the flag V in one entry NENT of interest is set during a period in which the flag signal FLG is at a low level, the check circuit CHKN outputs a start signal STT1 to the counter COUNT to start the count operation. Conversely, at a timing in which the flag signal FLG changes from a high level to a low level, the check circuit CHKN outputs the start signal STT1 when the flag V of one entry NENT of interest is detected as having been set.

The check circuit CHKN resets the flag V of the entry NENT which has output the corresponding access request NREQ1 on the basis of the reset signal RST from the cache memory control unit 250B illustrated in FIG. 5. When the flag V of one entry NENT of interest is reset, the check circuit CHKN stops the operation of the counter COUNT and resets the counter value. Afterwards, the check circuit CHKN selects the next entry NENT, outputs the start signal STT1 when the flag V is detected as having been set, and then starts the count operation in the counter COUNT.

Also, when the flag V is detected as having been set during a period in which the flag signal FLG is at a high level, the check circuit CHKN resets the corresponding flag N. When the flag V of the entry NENT which caused the output of a warning notification WARN1 is reset during a period in which the flag signal FLG is at a high level, the check circuit CHKN outputs an bypass notification AVID1 to the arbitrating unit 240B. That is to say, when the access request NREQ stored in the selected entry NENT is processed during a period in which the flag signal FLG is at a high level, the check circuit CHKN outputs the bypass notification AVID1.

Further, the check circuit CHKN resets all flags N based on the changing of the flag signal FLG to level in accordance with the bypass notification AVID1. Further, the check circuit CHKN in the port MIP2 outputs an bypass notification AVID2 to the arbitrating unit 240B. The check circuit CHKN in the port PFP1 outputs an bypass notification AVID3 to the arbitrating unit 240B. The check circuit CHKN in the port PFP2 outputs an bypass notification AVID4 to the arbitrating unit 240B.

The frequency dividing circuit DIV divides a clock CLK frequency, and outputs this to the counter COUNT. The counter COUNT synchronizes to the clock for which the frequency has been divided and performs the count operation in response to the start signal STT1 from the check circuit CHKN. When the counter value has reached a predetermined value, the counter COUNT outputs the warning notification WARN1 to the arbitrating unit 240B. That is to say, the counter COUNT outputs the warning notification WARN1 to the arbitrating unit 240B on the basis that a predetermined time Tmax has elapsed from the time at which the access request NREQ1 has been stored in one entry NENT of interest. The frequency dividing circuit DIV and the counter COUNT start calculating time in response to the start signal STT1, and functions as a timer to output the warning notification WARN1 when the predetermined time Tmax elapsed.

Further, the counter COUNT in the port MIP2 outputs a warning notification WARN2 to the arbitrating unit 240B. The counter COUNT in the port PFP1 outputs a warning notification WARN3 to the arbitrating unit 240B. The counter COUNT in the port PFP2 outputs a warning notification WARN4 to the arbitrating unit 240B.

FIG. 7 illustrates examples of the ports MOP1, MOP2, MIBP1, and MIBP2 illustrated in FIG. 5. The ports MOP1, MOP2, MIBP1, and MIBP2 have the same or similar configuration, and so only the port MIBP1 will be described here. The port MIBP1 includes a port unit PORTS, the entry selection unit ESEL, a check circuit CHKS, the frequency dividing circuit DIV, and the counter COUNT. Further, the port MIBP1 does not include the control unit CNT and the issuance control unit REQCNT in the port MIP1 illustrated in FIG. 6.

As illustrated by the heavy border in FIG. 7, the port unit PORTS includes, for example, four units of the entry SENT for storing the access request SREQ1. Further, the unit number of the entry SENT is not limited to four. Each entry SENT includes an address region ADR for storing addresses representing storage regions of the recording device 300 where data is stored, and a flag V. The flag V represents whether the address stored in the address region ADR is valid or invalid. Each address region may be 32 bits in length, for example, and each flag V is one bit.

The entry selection unit ESEL is the same or similar to the entry selection unit ESEL illustrated in FIG. 6, except for the receiving of the address stored in the address region ADR without going through the buffer BUF illustrated in FIG. 6. That is to say, the entry selection unit ESEL sequentially selects addresses from all buffers BUF using a method such as a round robin method, for example, and outputs the selected address to the arbitrating unit 240B as an access request SREQS1. Further, the entry selection unit ESEL in the port MOP2 outputs an access request SREQS2 to the arbitrating unit 240B. The entry selection unit ESEL in the port MIBP1 outputs an access request SREQS3 to the arbitrating unit 240B. The entry selection unit ESEL in the port MIBP2 outputs an access request SREQ4 to the arbitrating unit 240B.

The check circuit CHKS sequentially selects the entry SENT for which the flag V is to be checked using a method such a round robin method, for example. When the check circuit CHKS detects that the flag V in the selected entry SENT is set, the check circuit CHKS outputs a start signal STT2 to the counter COUNT to start the count operation. The check circuit CHKS resets the flag V of the entry SENT which has output the corresponding access request SREQ1 on the basis of the reset signal RST from the cache memory control unit 250B illustrated in FIG. 5.

When the check circuit CHKS detects that the selected entry SENT from among the units of entry SENT for which the flag V is set is reset, the check circuit CHKS resets the counter COUNT. Afterwards, the check circuit CHKS selects the next entry SENT, and starts the count operation in the counter COUNT when the flag V is detected as having been set.

When the flag V of the entry SENT which caused the output of the warning notification WARNS1 is reset, the check circuit CHKS outputs a bypass notification AVIDS1 to the arbitrating unit 240B. That is to say, when the access request SREQ stored in the selected entry SENT is processed, the check circuit CHKS outputs the bypass notification AVIDS1.

Further, the check circuit CHKN in the port MOP2 outputs a bypass notification AVIDS2 to the arbitrating unit 240B. The check circuit CHKN in the port MIBP1 outputs a bypass notification AVIDS3 to the arbitrating unit 240B. The check circuit CHKN in the port MIBP2 outputs a bypass notification AVIDS4 to the arbitrating unit 240B.

The frequency dividing circuit DIV and the counter COUNT are the same or similar to the frequency dividing circuit DIV and the counter COUNT illustrated in FIG. 6. That is to say, the counter COUNT synchronizes to the clock for which the frequency has been divided and performs the count operation in response to the start signal STT2 from the check circuit CHKS. When the counter value has reached a predetermined value, the counter COUNT outputs the warning notification WARNS1 to the arbitrating unit 240B.

That is to say, the counter COUNT outputs the warning notification WARNS1 to the arbitrating unit 240B on the basis that a predetermined time Tmax has elapsed from the time at which the access request SREQ3 has been stored in one entry SENT of interest. The frequency dividing circuit DIV and the counter COUNT start calculating time in response to the start signal STT2, and functions as a timer to output the warning notification WARNS1 when the predetermined time Tmax elapsed.

Further, the counter COUNT in the port MOP2 outputs a warning notification WARNS2 to the arbitrating unit 240B. The counter COUNT in the port MIBP1 outputs a warning notification WARNS3 to the arbitrating unit 240B. The counter COUNT in the port MIBP2 outputs a warning notification WARNS4 to the arbitrating unit 240B.

FIG. 8 illustrates an example of the arbitrating unit 240B illustrated in FIG. 5. The arbitrating unit 240B includes a generating circuit SETGEN for a flag set signal FSET0, a generating circuit RSTGEN for a flag reset FRSTO, and a flip-flop FF. The generating circuit SETGEN includes, for example, an OR circuit, and sets the flag set signal FSET0 to a high level when at least any one of the warning notifications WARN1 through WARN4 and WARNS1 through WARNS4 is at a high level.

The generating circuit RSTGEN sets the flag reset FRSTO to a high level when the bypass notifications AVID corresponding to the warning notification WARN in an active state are all at a high level. The flip-flop FF receives the flag set signal FSET0 by a set terminal S, and receives the flag reset FRSTO by a reset terminal R. The flip-flop FF synchronizes with the leading edge of the flag set signal FSET0 to set the flag signal FLG to a high level, and synchronizes with the leading edge of the flag reset signal FRSTO to set the flag signal FLG to a low level. As previously described, the flag signal FLG at a high level represents the configuration notification FSET, and the flag signal FLG at a low level represents the release notification FRST.

Further, in addition to the circuit illustrated in FIG. 8, the arbitrating unit 240B includes a circuit to sequentially select the access requests REQ stored in the ports MIP1, PFP1, MIP2, PFP2, MOP1, MOP3, MIPB1, and MIPB2.

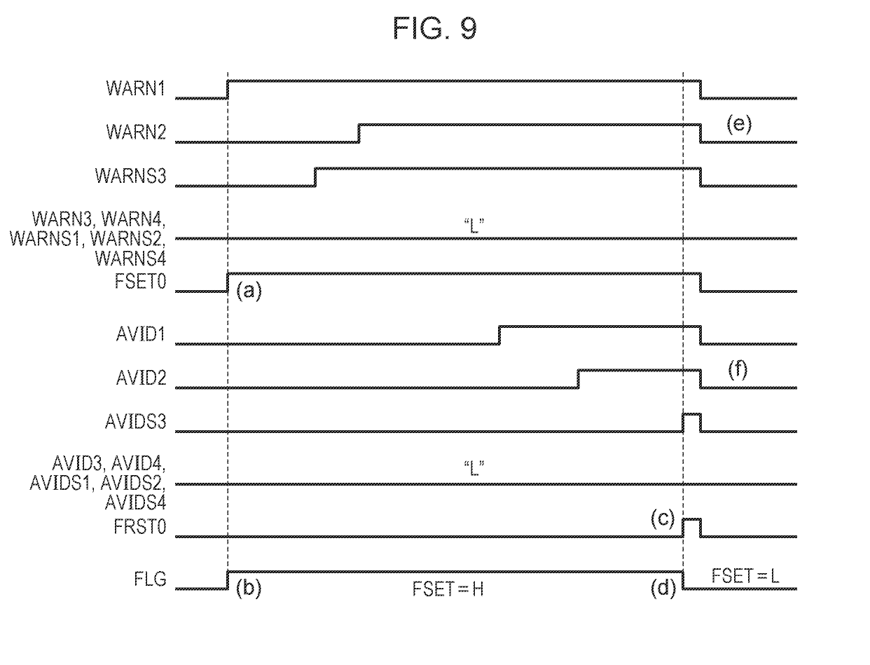

FIG. 9 illustrates an example of an operation of the arbitrating unit 240B illustrated in FIG. 8. According to this example, after the warning notification WARN1, WARN2, and WARNS1 are sequentially changed to a high level, the bypass notification AVID1, AVID2, and AVIDS3 are sequentially changed to a high level. The other warning notifications WARN and the other bypass notifications AVID are not output and remain at a low level.

The generating circuit SETGEN sets the flag set signal FSET0 to a high level in response to output of the first warning notification WARN1 (FIG. 9(a)). The flip-flop FF sets the flag signal FLG to a high level in response to the flag set signal FSET0, and outputs the configuration notification FSET (FIG. 9(b)).

Afterwards, the generating circuit RSTGEN sets the flag reset FRSTO to a high level on the basis that the bypass notification AVID1, AVID2, and AVIDS3 are output from all ports PT which have output the warning notification WARN (FIG. 9(c)). The flip-flop FF sets the flag signal FLG to a low level in response to the flag reset signal FRSTO, and outputs the release notification FRST (FIG. 9(d)).

Further, the ports PT that have not output the warning notification WARN do not output the bypass notification AVID. Also, the ports PT that have output the warning notification WARN reset the warning notification WARN and the bypass notification AVID to a low level on the basis that the flag signal FLG has changed from a high level to a low level (FIGS. 9(e) and 9(f)).

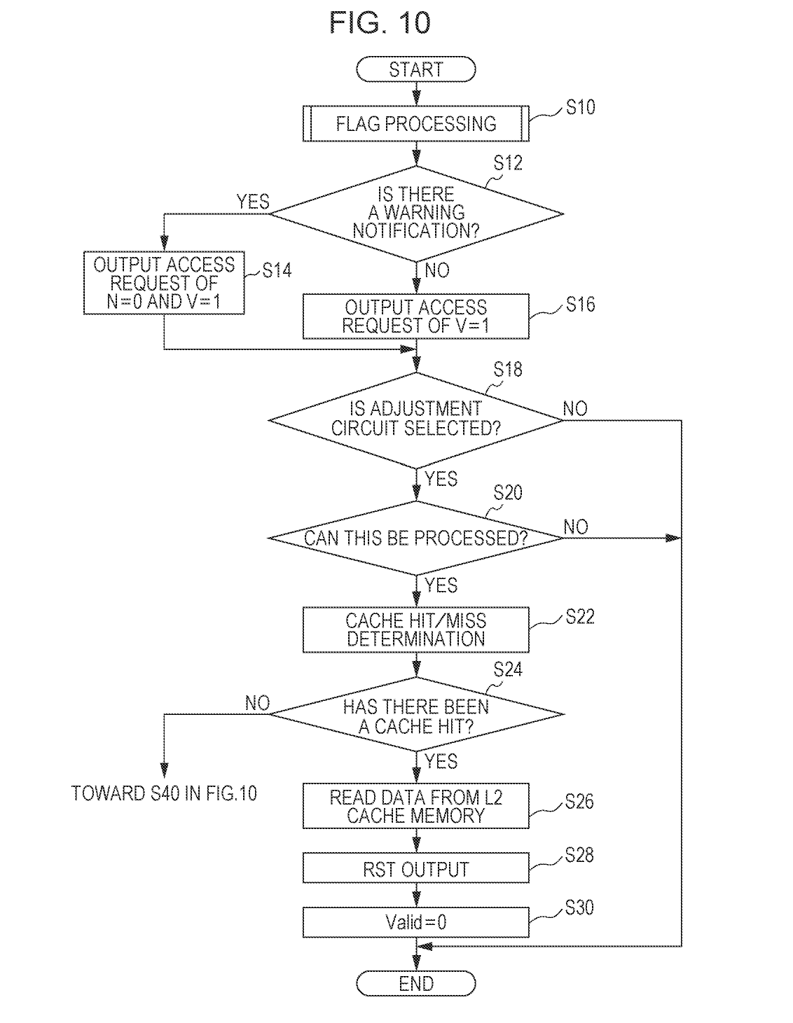

FIG. 10 illustrates an example of an operation of the information processing device 100B and the calculation processing device 200B when the access request NREQ1 is supplied to the port MIP1 illustrated in FIG. 5. That is to say, FIG. 10 illustrates an example of the control method of the information processing device 100B and the calculation processing device 200B. The flow illustrated in FIG. 10 may, for example, be implemented by hardware. Further, each step illustrated in FIG. 10 is separated so that the operation is readily understood, but in actual deployments, multiple steps may be executed in parallel by coordinating the hardware of the calculation processing device 200B.

The operation when the access request NREQ2 is supplied to the port MIP2, the operation when the access request NREQ3 is supplied to the port PFP1, and the operation when the access request NREQ4 is supplied to the port PFP2 are similar to that illustrated in FIG. 10. Also, before the operation in FIG. 10 starts, the core unit CORE1 stores at least one access request NREQ1 in the entry NENT in the port MIP1, and sets the flag V of the entry NENT storing the access request NREQ1 to a value of one. For example, the flow illustrated in FIG. 10 is repeatedly executed at a similar frequency to the frequency at which one access request NREQ1 is selected by the entry selection unit ESEL in the port MIP1 illustrated in FIG. 6.

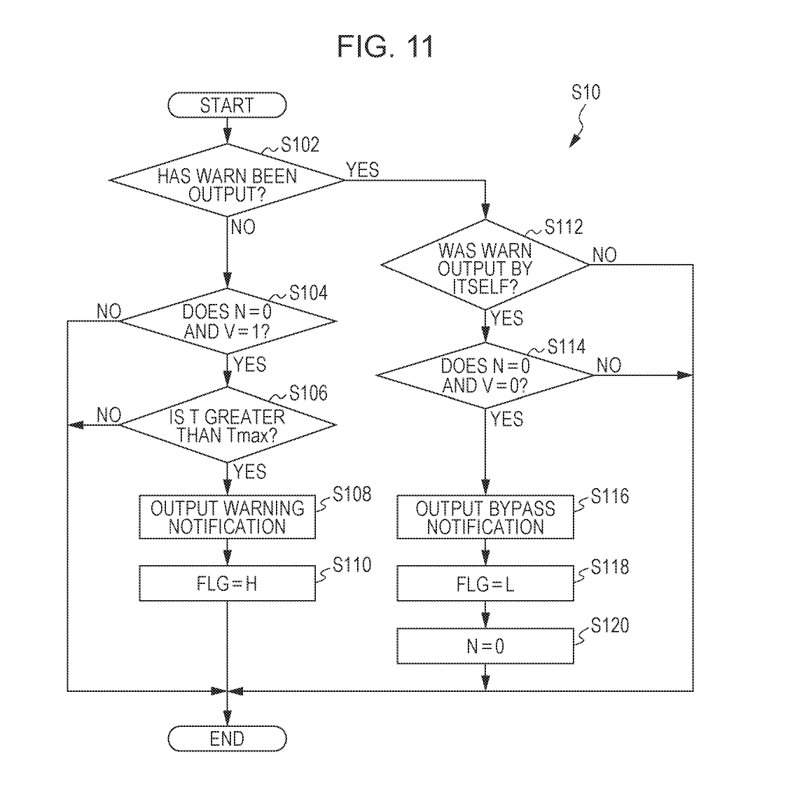

First, regarding a step S10, the port MIP1 checks the state of the flag N and V for the entry NENT of interest, the state of the flag signal FLG, and the value of the counter COUNT. Also, the port MIP1 determines whether or not the warning notification WARN1 or the bypass notification AVID1 has been output. Also, at the step S10, the arbitrating unit 240B determines the level of the flag signal FLG on the basis of the warning notification WARN1 or the bypass notification AVID1. An example of the step S10 is illustrated in FIG. 11.

Next, regarding a state S12, the issuance control unit REQCNT determines whether or not the flag signal FLG at a high level has been received from the arbitrating unit 240B on the basis of any of the warning notifications WARN1 through WARN4 and the WARNS1 through WARNS4. When the flag signal FLG at a high level based on any of the warning notifications WARN1 through WARN4 and the WARNS1 through WARNS4 has been received, the issuance control unit REQCNT executes operation of a step S14. When the flag signal FLG at a low level is received and none of the warning notification WARN1 through WARN4 and WARNS1 through WARNS4 are output, the issuance control unit REQCNT executes operation of a step S16.

At the step S14, the issuance control unit REQCNT outputs to the entry selection unit ESEL the access request NREQ1 stored in the entry NENT for which the flag N has been reset to zero, and the flag V has been set to one. That is to say, when the flag signal FLG is set to a high level on the basis of the warning notification WARN1, the port MIP1 outputs to the arbitrating unit 240B the access request NREQ1 for which the flag N is not set. The access request NREQ1 output from the issuance control unit REQCNT is, for example, the address stored in the address region ADR.

In this way, after the warning notification WARN1 is output, the access request NREQ1 placed in the entry NENT is not output by the arbitrating unit 240B. That is to say, the access request NREQ1 placed in the entry before the warning notification WARN1 and the access request NREQ1 placed in the entry after the warning notification WARN1 is differentiated by the flag N.

Conversely, regarding the step S16, the issuance control unit REQCNT outputs to the entry selection unit ESEL the access request NREQ1 stored in the entry NENT for which the flag V is set to a value of one regardless of the value of the flag N. The entry selection unit ESEL outputs one access request NREQ1 received from the issuance control unit REQCNT to the arbitrating unit 240B.

Regarding a step S18, when the access request NREQ1 is selected by the arbitrating unit 240B, and output to the cache memory control unit 250B, the operation transitions to a step S20. The access request NREQ1 selected by the arbitrating unit 240B is output to the cache memory control unit 250B. When the access request NREQ1 is not selected by the arbitrating unit 240B, the operation terminates.

Regarding the step S20, the cache memory control unit 250B determines whether or not the access request NREQ1 selected by the arbitrating unit 240B may be processed. When it may be processed, the operation transitions to a step S22. When it is may not be processed, the access request NREQ1 is aborted, and the operation terminates. Here, abortion is a state in which access processing is not executed on the access request NREQ1. When the access request NREQ1 is aborted, the data corresponding to the access request NREQ1 is not read out, and the port MIP1 continues to store the access request NREQ1. Abortion of access requests stored in other ports is handled in the same way.

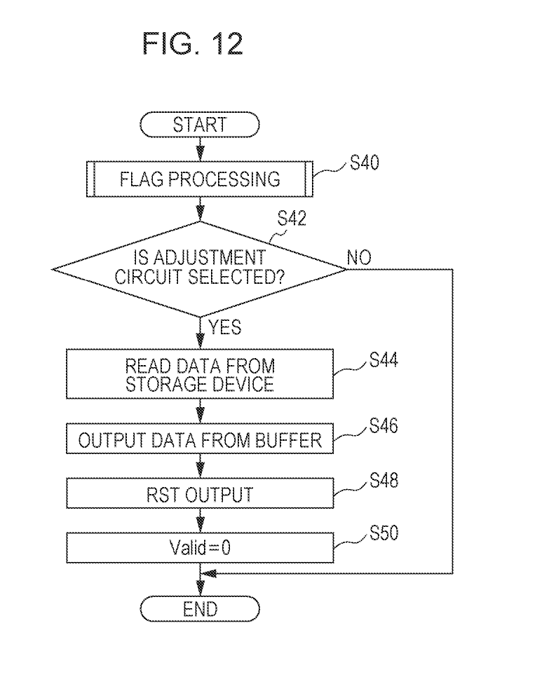

Regarding the step S22, the cache memory control unit 250B determines whether there is a cache hit or cache miss in the L2 cache memory 270B on the basis of the received access request NREQ1. Regarding a step S24, when there is a cache hit, the operation transitions to a step S26, and when there is a cache miss, the operation transitions to a step S40 illustrated in FIG. 12.

Next, regarding the step S26, the cache memory control unit 250B reads out the data from the L2 cache memory 2706, and outputs the read out data to the core CORE1. Next, regarding a step S28, the cache memory control unit 250B outputs the reset signal RST to the port MIP1 storing the access request NREQ1 on the basis that the data readout operation is complete.

Also, regarding a step S30, the check circuit CHKN in the port MIP1 resets the flag V for the entry NENT storing the access request NREQ1, regarding which a read operation has been performed, to zero on the basis of the reset signal RST. As a result, the access request NREQ1 for which the readout operation has been executes is disabled. Further, steps S28 and S30 may be executed together with step S22 and step S26.

FIG. 11 illustrates an example of the operation of step S10 illustrated in FIG. 10. The operation as in FIG. 11 is executed by each check circuit CHKN in the ports MIP1, MIP2, PFP1, and PFP2. The operation will be described using the example as executed by the check circuit CHKN in the port MIP1.

First, regarding a step S102, the check circuit CHKN determines whether or not any of the warning notifications WARN1 through WARN4 and WARNS1 through WARNS4 have been output. For example, when the flag signal FLG continues at a high level, the check circuit CHKN determines that the warning notifications WARN1 through WARN4 and WARNS1 through WARNS4 were output. When any of the warning notifications WARN1 through WARN4 and WARNS1 through WARNS4 are output, the operation transitions to a step S112. When none of the warning notifications WARN1 through WARN4 and WARNS1 through WARNS4 are output, the operation transitions to a step S104.

Regarding the step S104, the check circuit CHKN resets the flag N of the entry NENT of interest to zero, and determines whether or not the flag V is set to one. That is to say, the check circuit CHKN determines whether or not the entry NENT of interest is storing the access request NREQ. When the entry NENT of interest is storing the access request NREQ, the operation transitions to a step S106, and when the entry NENT of interest is not storing the access request NREQ, the processing terminates.

Next, regarding the step S106, the counter COUNT determines whether or not the predetermined time T from the time the access request NREQ1 has been stored in one entry NENT of interest has elapsed a predetermined time Tmax. If the predetermined time Tmax has elapsed, a determination is made that there is a possibility that the core CORE may hang up due to the fact that the access request NREQ1 has not been processed for a prolonged time, and the operation transitions to a step S108. If the predetermined time Tmax has not elapsed, there is no possibility of a hang up, and so the operation terminates.

Next, regarding the step S108, the counter COUNT outputs the warning notification WARN1 to the arbitrating unit 240B on the basis that the storage time T regarding the access request NREQ1 in the entry NENT is over the predetermined time Tmax. Next, regarding a step S110, the arbitrating unit 240B changes the flag signal FLG from a low level to a high level on the basis of the warning notification WARN1, and the operation terminates. Further, the flag N is set for the ports MIP1, MIP2, PFP1, and PFP2 which received the flag signal FLG at a high level when storing a new access request NREQ in entry NENT.

Conversely, regarding the step S112, when any of the warning notification WARN1 through WARN4 and WARNS1 through WARNS4 are output, the check circuit CHKN determines whether or not the warning notification WARN1 has been output from the counter COUNT in the port MIP1. When the warning notification WARN1 has been output from the port MIP1, the operation transitions to a step S114, and when the warning notification WARN1 has not been output from the port MIP1, the operation terminates.

Regarding the step S114, the check circuit CHKN resets the flag N for the entry NENT of interest to zero, and determines whether or not the flag V is set to zero. When both flags N and V for the entry NENT of interest are zero, the access request NREQ1 that caused the warning notification WARN1 is determined to have been processed, and the operation transitions to a step S116. When the flag N is zero and the flag V is one for the entry NENT of interest, the access request NREQ1 which caused the warning notification WARN1 is determined to still not have processed, and the processing terminates.

Regarding the step S116, the check circuit CHKN determines the possibility of a hang up has been avoided due to the processing of the access request NREQ1, and outputs the bypass notification AVID1 to the arbitrating unit 240B. Next, regarding a step S118, the arbitrating unit 240B receives the bypass notification AVID1, and changes the flag signal FLG from a high level to a low level.

Next, regarding a step S120, the check circuit CHKN in each port MIP1, MIP2, PFP1, and PFP2 resets the flag N to zero on the basis that the flag signal FLG has been changed from a high level to a low level. As a result, access requests NREQ1 stored in each port MIP1, MIP2, PFP1, and PFP2 after the warning notification WARN1 are handled as older access requests NREQ when any of the warning notification WARN1 through WARN4 are output next. The operation terminates here.

FIG. 12 illustrates an example of an operation of the information processing device 100B and the calculation processing device 200B when the access request SREQ3 is supplied to the port MIBP1 illustrated in FIG. 5. That is to say, FIG. 12 illustrates an example of the control method of the information processing device 100B and the calculation processing device 200B. The flow illustrated in FIG. 12 may, for example, be implemented by hardware. Further, each step illustrated in FIG. 12 is separated so that the operation is readily understood, but in actual deployments, multiple steps may be executed in parallel by coordinating the hardware of the calculation processing device 200B.

The operation when the access request SREQ1 is supplied to the port MOP1, the operation when the access request SREQ2 is supplied to the port MOP2, and the operation when the access request SREQ4 is supplied to the port MIBP2 are similar to that illustrated in FIG. 12. Also, before the operation in FIG. 12 starts, the cache memory control unit 250B stores at least one access request SREQ3 in the entry SENT in the port MIBP1. Further, before the operation in FIG. 12 starts, the cache memory control unit 250B sets the flag V for the entry SENT storing the access request SREQ3 to one. For example, the flow illustrated in FIG. 12 is repeatedly executed at a similar frequency to the frequency at which one access request SREQ3 is selected by the entry selection unit ESEL in the port MIBP1 illustrated in FIG. 7.

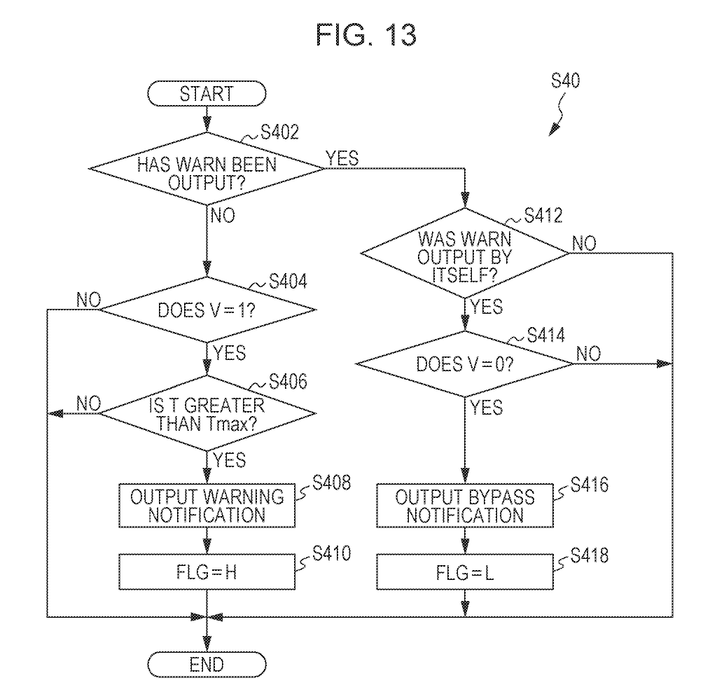

First, regarding a step S40, the port MIBP1 checks the state of the flag V for the entry SENT of interest and the value of the counter COUNT. Also, the port MIBP1 determines whether or not the warning notification WARNS3 or the bypass notification AVIDS3 has been output. Also, the arbitrating unit 240B determines the logical level of the flag signal FLG on the basis of the warning notification WARNS3 or the bypass notification AVIDS3. An example of the step S40 is illustrated in FIG. 13.

Next, regarding a step S42, when the access request SREQ3 is selected by the arbitrating unit 240B, and output to the cache memory control unit 250B, the operation transitions to a step S44. When the access request SREQ3 is not selected by the arbitrating unit 240B, the operation terminates.

At the step S44, the cache memory control unit 250B outputs the access request SREQ3 to the memory access controller 280B. The memory access controller 280B accesses the recording device 300 on the basis of the access request SREQ3 from the cache memory control unit 250B, and outputs the data read out from the recording device 300 to the data buffer BUF1.

Next, regarding a step S46, the data buffer BUF1 outputs to the L2 cache memory 270B and the core unit CORE1 the data stored by the memory access controller 280B. However, when the data stored by the memory access controller 280B is read out from the recording device 300 on the basis of the access request SREQ1, which is the prefetch instruction, the data buffer BUF1 does not output the data to the core unit CORE1.

Next, regarding a step S48, the cache memory control unit 250B outputs the reset signal RST to the port MIBP1 storing the access request SREQ3 on the basis that the readout of the data is complete. The determination that the read out of the data is complete may be made by the storage of the data in the data buffer BUF1 by the memory access controller 280B or the output of the data from the data buffer BUF1.

Next, regarding a step S50, the check circuit CHKS in the port MIBP1 resets the flag V for the entry SENT storing the access request SREQ3 to zero on the basis of the reset signal RST. As a result, the access request SREQ3 is disabled. The operation also terminates here. Further, the steps S48 and S50 may be executed together with step S44 or step S46.

FIG. 13 illustrates an example of the operation of step S40 illustrated in FIG. 11. Detailed description of operations that are similar to that of FIG. 11 will be omitted. Steps S402, S406, S408, S410, S412, S416, and S418 illustrated in FIG. 13 are similar to the operations of steps S102, S106, S108, S110, S112, S116, and S118 illustrated in FIG. 10. Further, the operations as in FIG. 13 are executed by each check circuit CHKS in ports MOP1, MOP2, MIBP1, and MIBP2. The example described here will be the operation as executed by the check circuit CHKS in the port MIBP1.

First, regarding a step S402, the check circuit CHKN determines whether or not any of the warning notifications WARN1 through WARN4 and WARNS1 through WARNS4 have been output. When none of the warning notifications WARN1 through WARN4 and WARNS1 through WARNS4 are output, regarding the step S404, the check circuit CHKS determines whether or not the flag V for one entry SENT of interest is set to one. That is to say, the check circuit CHKS determines whether or not the entry SENT of interest is storing the access request SREQ. When the entry SENT of interest is storing the access request SREQ, the operation transitions to step S406, and then the entry SENT of interest is not storing the access request SREQ, processing terminates.

Regarding the step S406, the counter COUNT determines whether or not the predetermined time Tmax has elapsed from the time the access request SREQ3 has been stored in one entry SENT of interest. If the predetermined time Tmax has not elapsed, there is no possibility of a hang up, and so the operation terminates. Regarding the step S408, the counter COUNT outputs the warning notification WARNS3 to the arbitrating unit 240B on the basis that the storage time T regarding the access request SREQ3 in the entry SENT is over the predetermined time Tmax.

Next, regarding a step S410, the arbitrating unit 240B outputs the configuration notification FSET to the ports MIP1, MIP2, PFP1, and PFP2 by changing the flag signal FLG from a low level to a high level on the basis of the warning notification WARNS1, and the operation terminates.

Conversely, regarding the step S412, when any of the warning notification WARN1 through WARN4 and WARNS1 through WARNS4 are output, the check circuit CHKS determines whether or not the warning notification WARNS3 has been output from the counter COUNT in the port MIBP1. When the warning notification WARNS3 has not been output from the port MIBP1, the operation terminates.

Regarding the step S414, when the warning notification WARNS3 has been output, the check circuit CHKS determines whether or not the flag V for one entry SENT of interest is set to zero. When the flag V is set to one for the entry SENT of interest, processing terminates. When the flag V is set zero for the entry SENT of interest, regarding the step S416, the check circuit CHKS determines that there is a possibility of a hang up having been avoided due to the processing of the access request SREQ3, and so outputs the bypass notification AVIDS3 to the arbitrating unit 240B. Next, regarding a step S418, the arbitrating unit 240B receives the bypass notification AVIDS3, outputs the release notification FRST to the ports MIP1, MIP2, PFP1, and PFP2 by changing the flag signal FLG from a high level to a low level, and the operation terminates.

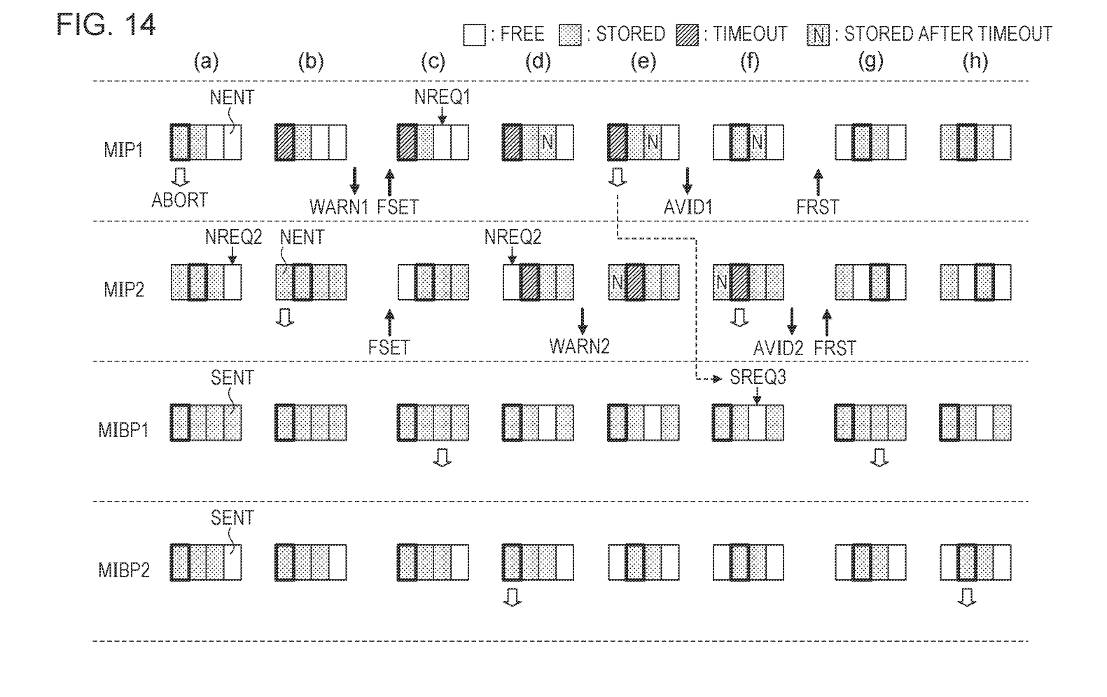

FIG. 14 illustrates an example of an operation of the information processing device 100B and the calculation processing device 200B illustrated in FIG. 5. That is to say, FIG. 14 illustrates an example of the control method of the information processing device 100B and the calculation processing device 200B. Detailed descriptions of operations that are the same or similar to those in FIG. 2 and FIG. 3 are omitted. The pattern of shaded areas, diagonal lines, and other symbols illustrating the state of the entry NENT and entry SENT have the same meaning as those in FIG. 2 and FIG. 3. In FIG. 14, the white arrow pointing downwards represents an access request selected by the arbitrating unit 240B.

According to the present example, for the sake of discussion, the calculation processing device 200B includes four ports PT (MIP1, MIP2, MIBP1, and MIBP2). The entry NENT and SENT with heavy borders are entries of interest by the check circuit CHKN in each of the ports MIP1 and MIP2, and by the check circuit CHKS in each of the ports MIBP1 and MIBP2.

At an initial state (a), all units of the entry SENT in the port MIPB1 store the access request SREQ3 (FIG. 5). The port MIP2 receives the access request NREQ2 from the core unit CORE2. The arbitrating unit 240B selects the access request NREQ1 stored in the entry NENT of the port MIP1 (FIG. 5), and outputs this to the cache memory control unit 250B.

The cache memory control unit 250B determines a cache miss on the basis of the access request NREQ1, and also determines that the access request SREQ3, which is a derived instruction, has to be issued. However, as all units of the entry SENT in the port MIPB1 are full, the cache memory control unit 250B does not issue the access request SREQ3. That is to say, the access request NREQ1 stored in the port MIP1 is aborted.

Next, regarding a state (b), the arbitrating unit 240B selects the access request NREQ2 stored in the entry NENT of the port MIP2, and outputs this to the cache memory control unit 250B. The cache memory control unit 250B determines a cache hit on the basis of the access request NREQ2, and accesses the L2 cache memory 270B. The cache memory control unit 250B outputs the data read out from the L2 cache memory 270B to the core unit CORE2, and outputs the reset signal RST (FIG. 5) and the completion signal FIN (FIG. 5).

The counter COUNT in the port MIP1 outputs the warning notification WARN1 on the basis that the predetermined time Tmax has elapsed from the time the access request NREQ1 has been stored in the entry NENT of interest. The arbitrating unit 240B outputs the configuration notification FSET by changing the flag signal FLG from a low level to a high level on the basis of the warning notification WARN1.

Next, regarding a state (c), the port MIP1 receives the access request NREQ1 from the core unit CORE1. The port MIP1 differentiates and stores (into the entry NENT to which an N has been added at a state (d)) the access request NREQ1 received after the configuration notification FSET from the access request NREQ1 stored before the configuration notification FSET.

The arbitrating unit 240B selects the access request SREQ3 stored in the entry SENT of the port MIBP1, and outputs this to the cache memory control unit 250B. The cache memory control unit 250B outputs the access request SREQ3 to the memory access controller 280B, and reads out the data corresponding to the access request SREQ3 from the recording device 300. Afterwards, the cache memory control unit 250B outputs the data read out from the recording device 300 to the core unit CORE2 through the data buffer BUF1, and outputs the reset signal RST and the completion signal FIN.

Regarding a state (d), the port MIP2 receives the access request NREQ2 from the core unit CORE2. The port MIP2 differentiates and stores (into the entry NENT to which an N has been added at a state (e)) the access request NREQ2 received after the configuration notification FSET from the access request NREQ2 stored before the configuration notification FSET.

Also, the counter COUNT in the port MIP2 outputs the warning notification WARN2 on the basis that the predetermined time Tmax has been reached from the time the access request NREQ2 has been stored in the entry NENT of interest. The arbitrating unit 240B receives the warning notification WARN1 from the port MIP1, and so ignores the warning notification WARN2.

The arbitrating unit 240B selects the access request SREQ4 (FIG. 5) stores in the entry SENT of the port MIBP2, and outputs this to the cache memory control unit 250B. The cache memory control unit 250B outputs the access request SREQ4 to the memory access controller 280B, and reads out the data corresponding to the access request SREQ4 from the recording device 300.

Afterwards, the cache memory control unit 250B outputs the data read out from recording device 300 to the core unit CORE2 through the data buffer BUF2. Also, the cache memory control unit 250B outputs the completion signal FIN to the core unit CORE2, and outputs the reset signal RST to the port MIBP2. The check circuit CHKS of the port MIBP2 receives the reset signal RST, detects that the access request SREQ4 stored in the entry SENT of interest has been processed, and switches the entry SENT of interest.

Next, regarding a state (e), the arbitrating unit 240B reselects the access request NREQ1 stored in the entry NENT of the port MIP1, and outputs this to the cache memory control unit 250B. The cache memory control unit 250B determines a cache miss on the basis of the access request NREQ1, and generates an access request SREQ3, which is a derived instruction, based on the access request NREQ1. The entry SENT in the port MIBP1 is free at this time, and so the cache memory control unit 250B outputs the access request SREQ3 to the port MIBP1.

The cache memory control unit 250B outputs the reset signal RST to the port MIP1 on the basis that the access request SREQ3 has been output to the port MIBP1. The check circuit CHKN in the port MIP1 receives the reset signal RST, detects that the access request NREQ1 stored in the entry NENT of interest has been processed, and switches the entry NENT of interest.

Also, the check circuit CHKN outputs the bypass notification AVID1 to the arbitrating unit 240B as the predetermined time Tmax has elapsed for the access request NREQ1 stored in the entry NENT of interest. However, the arbitrating unit 240B has not received the bypass notification AVID2 corresponding to the other warning notification WARN2, and so ignores the bypass notification AVID1.

Next, regarding a state (f), the port MIPB1 stores the access request SREQ3 from the cache memory control unit 250B into a free entry SENT. Also, the arbitrating unit 240B selects the access request NREQ2 stored in the entry NENT of the port MIP2, and outputs this to the cache memory control unit 250B. The cache memory control unit 250B determines a cache hit on the basis of the access request NREQ2, and accesses the L2 cache memory 270B. The cache memory control unit 250B outputs the data read out from the L2 cache memory 270B to the core unit CORE2. Also, the cache memory control unit 250B outputs the completion signal FIN to the core unit CORE2, and outputs the reset signal RST to the port MIP2.

The check circuit CHKN in the port MIP2 receives the reset signal RST, detects that the access request NREQ2 stored in the entry NENT of interest has been processed, and switches the entry NENT of interest. Also, the check circuit CHKN in the port MIP2 outputs the bypass notification AVID2 to the arbitrating unit 240B as the access request NREQ2, which has been stored in the entry NENT of interest longer than the predetermined time Tmax, has been processed.

As the arbitrating unit 240B receives both bypass notifications AVID1 and AVID2 corresponding to the overlapping warning notifications WARN1 and WARN2, the arbitrating unit 240B outputs the release notification FRST by changing the flag signal FLG from a high level to a low level. The ports MIP1 and MIP2 that output the warning notification WARN and the bypass notification AVID stop the output of the warning notification WARN and the bypass notification AVID in response to the release notification FRST. The port MIP1 resets the flag N, and stores the access request NREQ1 stored after the warning notification WARN without differentiating from the access request NREQ1 stored before the warning notification WARN. Similarly, the port MIP2 resets the flag N, and stores the access request NREQ2 stored after the warning notification WARN1 without differentiating from the access request NREQ2 stored before the warning notification WARN1.

Next, regarding a state (g), the arbitrating unit 240B selects the access request SREQ3 stored in the entry SENT in the port MIBP1, and outputs this to the cache memory control unit 250B. The cache memory control unit 250B outputs the access request SREQ3 to the memory access controller 280B, and reads out the data corresponding to the access request SREQ3 from the recording device 300. The cache memory control unit 250B outputs the data read out from the recording device 300 to the core unit CORE1 through the data buffer BUF1. Also, the cache memory control unit 250B outputs a completion signal FIN to the core unit CORE1. Moreover, the cache memory control unit 250B outputs the reset signal RST to the port MIBP1 on the basis of the output of the access request SREQ3.

Further, regarding actual operations, the access time to read out the data from the recording device 300 after the access request SREQ3 is output to the memory access controller 280B is longer than the access time of the L2 cache memory 270B. However, for the sake of discussion, let us assume that the data is read out from the recording device 300 and the completion signal FIN is output during the period of the state (g) according to the present example.

Next, regarding a state (h), the arbitrating unit 240B selects the access request SREQ4 stored in the entry SENT of the port MIBP2, and outputs this to the cache memory control unit 250B. The cache memory control unit 250B outputs the access request SREQ4 to the memory access controller 280B, and reads out the data corresponding to the access request SREQ4 from the recording device 300.

Afterwards, the cache memory control unit 250B outputs the data read out from the recording device 300 to the core unit CORE2 through the data buffer BUF2. Also, the cache memory control unit 250B outputs the completion signal FIN to the core unit CORE2, and outputs the reset signal RST to the port MIBP2. The check circuit CHKS in the port MIBP2 receives the reset signal RST, detects that the access request SREQ4 stored in the entry SENT of interest has been processed, and switches the entry SENT of interest.

Thus, according to the present embodiment, failures in which the processing of the access requests SREQ, which are the derived requests, may be resolved, and the delay of access request NREQ processing may be avoided similarly to the embodiment as illustrated in FIG. 1 and FIG. 3. As a result, the probability of the core units CORE hanging up due to older access requests NREQ not being processed may be decreased as compared to the related art, and the subsequent drop in performance of the information processing device 100B and the calculation processing device 200B may be suppressed.

Further, the issuance control unit REQCNT illustrated in FIG. 6 enables control of whether or not to output the access request NREQ for every entry NENT to the arbitrating unit 240B on the basis of the flag signal FLG and flags N and V. By setting the flag N, the check circuit CHKN enables classification of the access requests NREQ newly stored in the ports MIP1, MIP2, PFP1, and PFP2 during the period in which the flag signal FLG is at a high level (period of setting notification FSET). As a result, older access requests NREQ before the output of the warning notification WARN1 are selectively output to the arbitrating unit 240B during the period in which the flag signal FLG is at a high level.

The check circuit CHKN enables the minimization of the counter COUNT values regardless of the unit number of entry NENT by selecting one entry NENT of interest and operating the counter COUNT depending on the state of the entry NENT of interest. As a result, the circuit size of the calculation processing device 200B may be reduced in comparison to a case in which the counter COUNT is provisioned in each entry NENT.

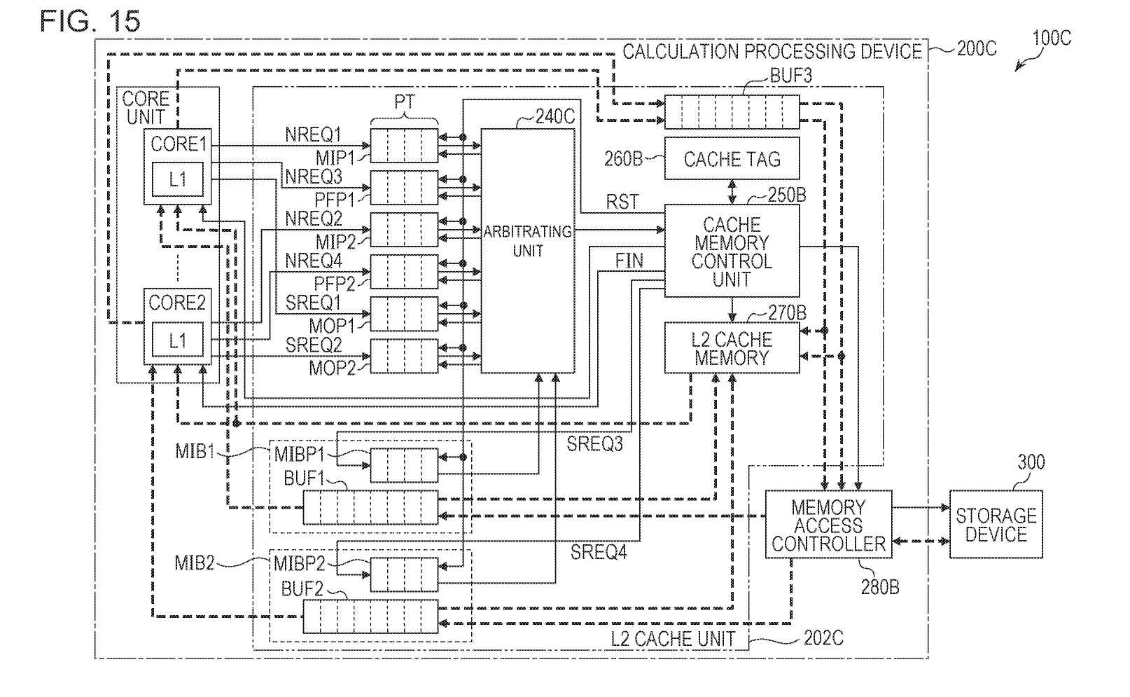

FIG. 15 illustrates an example of an information processing device 100C and a calculation processing device 200C according to another embodiment. Elements that are the same or similar as that in FIG. 5 have the same reference numerals and their detailed descriptions have also been omitted.

The information processing device 100C includes the calculation processing device 200C and the recording device 300. The information processing device 100C may be, for example, a computer device such as a server or a personal computer, and the calculation processing device 200C may be a processor such as a CPU.

The information processing device 100C, calculation processing device 200C, and an L2 cache unit 202C included an arbitrating unit 240C in place of the arbitrating unit 240B illustrated in FIG. 5. Other configurations of the information processing device 100C, calculation processing device 200C, and an L2 cache unit 202C are similar to the information processing device 100B, calculation processing device 200B, and an L2 cache unit 202B illustrated in FIG. 5.

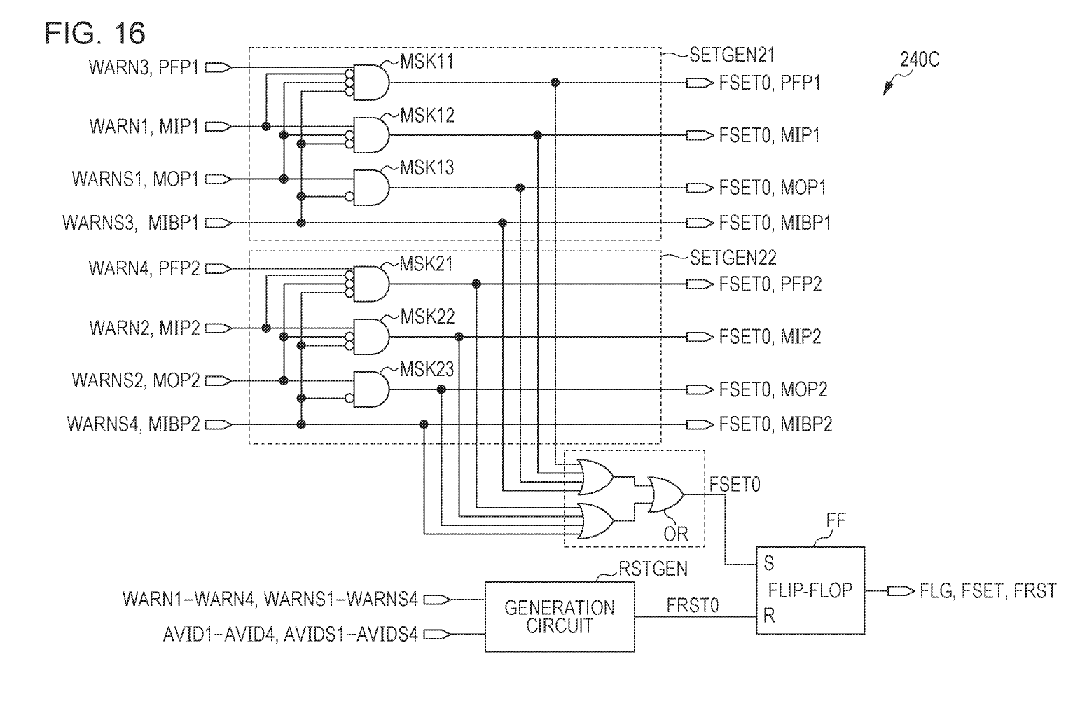

FIG. 16 illustrates an example of the arbitrating unit 240C illustrated in FIG. 15. Detailed description of elements that are the same or similar to that of FIG. 8 are omitted. The arbitrating unit 240C includes a generating circuit SETGEN21, a generating circuit SETGEN22, a generating circuit RSTGEN, an OR circuit OR, and a flip-flop FF. Also, in addition to the circuit illustrated in FIG. 16, the arbitrating unit 240C includes a circuit to sequentially select the access request REQ stored in the ports MIP1, PFP1, MIP2, PFP2, MOP1, MOP3, MIPB1, and MIBP2.

The generating circuit SETGEN21 includes mask circuits MSK11, MSK12, and MSK13. The mask circuit MSK11 outputs the flag set signal FSET0 (PFP1) in response to the warning notification WARN3 during a period in which the warning notifications WARN1, WARNS1, and WARNS3 have not been received. The mask circuit MSK11 masks the output of the flag set signal FSET0 (PFP1) corresponding to the warning notification WARN3 during a period in which any of the warning notifications WARN1, WARNS1, and WARNS3 is received.

The mask circuit MSK12 outputs the flag set signal FSET0 (MIP1) in response to the warning notification WARN1 during a period in which the warning notifications WARNS1 and WARNS3 have not been received. The mask circuit MSK12 masks the output of the flag set signal FSET0 (MIP1) corresponding to the warning notification WARN1 during a period in which either the warning notifications WARNS1 or WARNS3 is received. The mask circuit MSK13 outputs the flag set signal FSET0 (MOP1) in response to the warning notification WARNS1 during a period in which the warning notification WARNS3 has not been received. The mask circuit MSK13 masks the output of the flag set signal FSET0 (MOP1) corresponding to the warning notification WARNS1 during a period in which the warning notification WARNS3 is received.

The generating circuit SETGEN22 includes mask circuits MSK21, MSK22, and MSK23. The mask circuit MSK21 outputs the flag set signal FSET0 (PFP2) in response to the warning notification WARN4 during a period in which the warning notifications WARN2, WARNS2, and WARNS4 have not been received. The mask circuit MSK21 masks the output of the flag set signal FSET0 (PFP2) corresponding to the warning notification WARN4 during a period in which any of the warning notifications WARN2, WARNS2, and WARNS4 is received.

The mask circuit MSK22 outputs the flag set signal FSET0 (MIP2) in response to the warning notification WARN2 during a period in which the warning notifications WARNS2 and WARNS4 have not been received. The mask circuit MSK22 masks the output of the flag set signal FSET0 (MIP2) corresponding to the warning notification WARN2 during a period in which either the warning notifications WARNS2 or WARNS4 is received. The mask circuit MSK23 outputs the flag set signal FSET0 (MOP2) in response to the warning notification WARNS2 during a period in which the warning notification WARNS4 has not been received. The mask circuit MSK23 masks the output of the flag set signal FSET0 (MOP2) corresponding to the warning notification WARNS2 during a period in which the warning notification WARNS4 is received.

The OR circuit OR outputs the flag set signal FSET0 when any of the following flag set signals FSET0 are received: FSET0 (PFP1), FSET0 (MIP1), FSET0 (MOP1), FSET0 (MOP1), FSET0 (PFP2), FSET0 (MIP2), FSET0 (MOP2), and FSET0 (MOP2). Further, the flag set signal FSET0 (MIBP1) is output in response to the warning notification WARNS3, and the flag set signal FSET0 (MIBP2) is output in response to the warning notification WARNS4.

The arbitrating unit 240C changes the flag signal FLG from a low level to a high level on the basis of the flag set signals FSET0 (PFP1), FSET0 (MIP1), FSET0 (MOP1), FSET0 (MOP1), FSET0 (PFP2), FSET0 (MIP2), FSET0 (MOP2), and FSET0 (MOP2).

The arbitrating unit 240C sequentially selects one of the access requests REQ output from the ports PFP1, MIP1, MOP1, and MIBP1 when the flag set signal FSET0 (PFP1) is output. The arbitrating unit 240C does not select the access request REQ output from the port PFP1 when the flag set signal FSET0 (MIP1) is output. The arbitrating unit 240C sequentially selects one of the access requests REQ output from the ports PFP2, MIP2, MOP2, and MIBP2 when the flag set signal FSET0 (PFP2) is output. The arbitrating unit 240C does not select the access request REQ output from the port PFP2 when the flag set signal FSET0 (MIP2) is output.

The arbitrating unit 240C sequentially selects one of the access requests REQ output from the ports MIP1, MOP1, and MIBP1 when the flag set signal FSET0 (MIP1) is output. The arbitrating unit 240C sequentially selects one of the access requests REQ output from the ports MIP2, MOP2, and MIBP2 when the flag set signal FSET0 (MIP2) is output.

The arbitrating unit 240C sequentially selects one of the access requests REQ output from the ports MOP1, and MIBP1 when the flag set signal FSET0 (MOP1) is output. The arbitrating unit 240C does not select the access request REQ output from the port PFP1 and MIP1 when the flag set signal FSET0 (MOP1) is output. The arbitrating unit 240C sequentially selects one of the access requests REQ output from the ports MOP2, and MIBP2 when the flag set signal FSET0 (MOP2) is output. The arbitrating unit 240C does not select the access request REQ output from the port PFP2 and MIP2 when the flag set signal FSET0 (MOP2) is output.

The arbitrating unit 240C sequentially selects one of the access request REQ output from the port MIBP1 when the flag set signal FSET0 (MIBP1) is output. The arbitrating unit 240C does not select the access request REQ output from the port PFP1, MIP1, and MOP1 when the flag set signal FSET0 (MIBP1) is output. The arbitrating unit 240C sequentially selects one of the access request REQ output from the port MIBP2 when the flag set signal FSET0 (MIBP2) is output. The arbitrating unit 240C does not select the access request REQ output from the port PFP2, MIP2, and MOP2 when the flag set signal FSET0 (MIBP2) is output.

According to the present embodiment, when the warning notification WARNS1 is output from the port MOP1 storing the access request SREQ, which is the derived instruction, for example, the arbitrating unit 240C does not select the access request NREQ stored in the ports PFP1 and MIP1. That is to say, the arbitrating unit 240C arbitrates the derived instruction with priority when there is a port PT storing an access request SREQ that has reached the predetermined time Tmax.

As a result, the access request SREQ stored in the ports MOP1 and MIBP1 are processed with priority, for example, and the entry SENT in the ports MOP1 and MIBP1 may be freed. Therefore, possibility that the derived instruction generated on the basis of the access request NREQ stored in the ports MIP1 and PFP1 after the bypass notification AVIDS has been output will be stored in the ports MOP1 and MIBP1 may be increased. As a result, the probability that the access request NREQ selected by the arbitrating unit 240C will be aborted may be decreased, which may increase the performance of the information processing device 100C and the calculation processing device 200C.

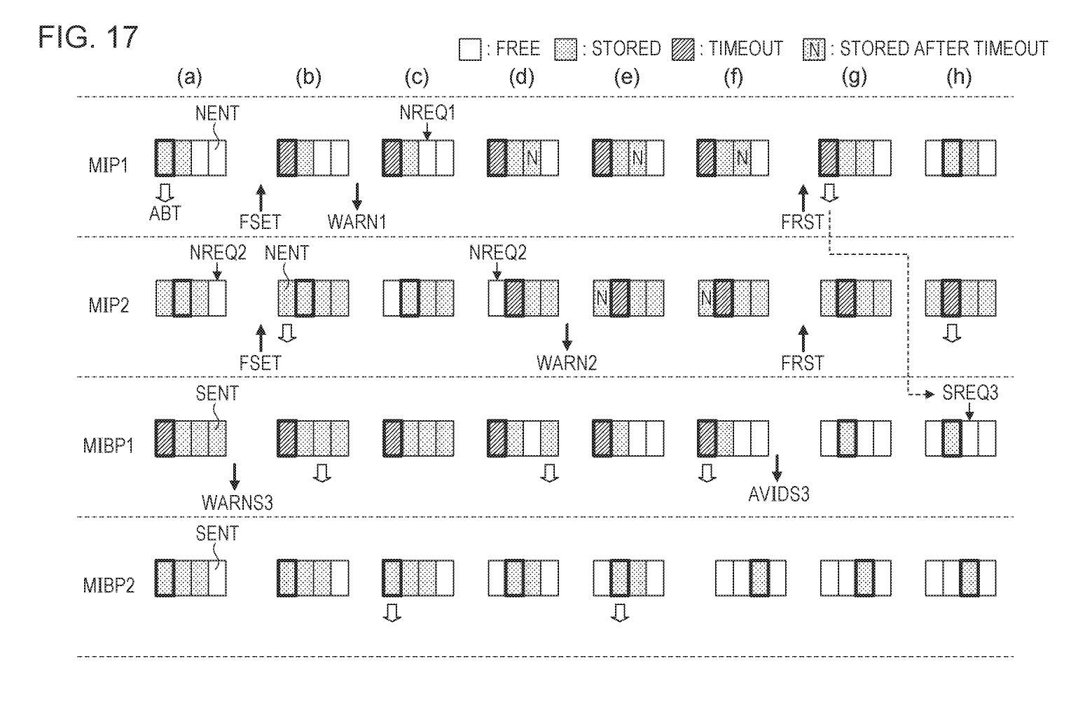

FIG. 17 illustrates an example of an operation of the information processing device 100C and the calculation processing device 200C illustrated in FIG. 15. That is to say, FIG. 17 illustrates an example of the control method of the information processing device 100C and the calculation processing device 200C. Detailed descriptions of operations that are the same or similar to that in FIG. 14 are omitted. According to the present example and similar to that in FIG. 14, the calculation processing device 200C includes four ports PT (MIP1, MIP2, MIBP1, and MIBP2).

The operations of the ports MIP1 and MIP2 for states (a) through (d) are similar to that as in FIG. 14. Regarding the state (a), the counter COUNT in the port MIBP1 outputs the warning notification WARNS3 on the basis that the time since the access request SREQ3 has been stored in the entry SENT of interest has passed the predetermined time Tmax. The arbitrating unit 240C changes the flag signal FLG from a low level to a high level on the basis of the warning notification WARNS3 to output the configuration notification FSET.

Afterwards, regarding the states (b) through (f), the arbitrating unit 240C gives priority to sequentially selecting the access requests SREQ (that is, the derived instruction) stored in the ports MIBP1 and MIBP2 on the basis of the warning notification WARNS3. That is to say, regarding the states (b) through (f), the access requests NREQ stored in the ports MIP1 and MIP2 are not selected.

Regarding the state (f), the arbitrating unit 240C selects the access request SREQ3 stored in the entry SENT of the port MIBP1, and outputs this to the cache memory control unit 250B. The check circuit CHKS in the port MIBP1 receives the reset signal RST, detects that the access request SREQ3 stored in the entry SENT of interest has been processed, and switches the entry SENT of interest.

Also, the check circuit CHKS in the port MIBP1 outputs the bypass notification AVIDS3 to the arbitrating unit 240C, as the access request SREQ3 stored in the entry SENT of interest for more than the predetermined time Tmax has been processed. The arbitrating unit 240C changes the flag signal FLG from a high level to a low level in response to the bypass notification AVIDS3 to output the release notification FRST. The ports MIP1 and MIP2 stop the output of the warning notification WARN1 and WARN2 in response to the flag signal FLG at a low level. Also, the ports MIP1 and MIP2 reset the flag N, and without any differentiation between the two, store the access request NREQ stored before the output of the warning notification WARN1 and WARN2 and the access request NREQ stored after the output of the warning notification WARN1 and WARN2.

Regarding the state (g), the arbitrating unit 240C selects the access request NREQ1 stored in the entry NENT of the port MIP1, and outputs this to the cache memory control unit 250B. The cache memory control unit 250B determines a cache miss on the basis of the access request NREQ1, and determines the access request SREQ3, which is the derived instruction, based on the access request NREQ1 is desirable.

The cache memory control unit 250B is able to output the access request SREQ3 to the port MIBP1 as the entry SENT in the port MIBP1 is sufficiently free as compared to the state (a) due to the operations performed in states (b) through (f). According to the present example, the access request NREQ1 is selected without abortion, and so the warning notification WARN1 is not output again from the port MIP1.

The cache memory control unit 250B outputs the reset signal RST to the port MIP1 on the basis of the output of the access request SREQ3 to the port MIBP1. The check circuit CHKN in the port MIP1 receives the reset signal RST, detects that the access request NREQ1 stored in the entry NENT of interest has been processed, and switches the entry NENT of interest.

Regarding the state (h), the port MIBP1 stores the access request SREQ3 from the cache memory control unit 250B in a free entry SENT. The arbitrating unit 240C selects the access request NREQ2 stored in the entry NENT of the port MIP2, and outputs this to the cache memory control unit 250B.

Thus, according to the present embodiment, the arbitrating unit 240C determines the access request NREQ and SREQ selected with priority regarding the ports PT that output the warning notification WARN and WARNS. When the access request SREQ has been stored in the port MIBP1 longer than the predetermined time Tmax, for example, the arbitrating unit 240C gives priority in selecting the access request SREQ stored in the ports MIBP1 and MIBP2. As a result, the entry SENT in the ports MIBP1 and MIBP2 storing the derived instructions may be freed quickly, and so any newly generated derived instructions may be stored in the entry SENT without abortion. As a result, the probability of core CORE hang ups due to older access requests NREQ not being processed may be lowered in comparison with the related art, which suppresses a decrease in the performance of the information processing device 100C and the calculation processing device 200C.

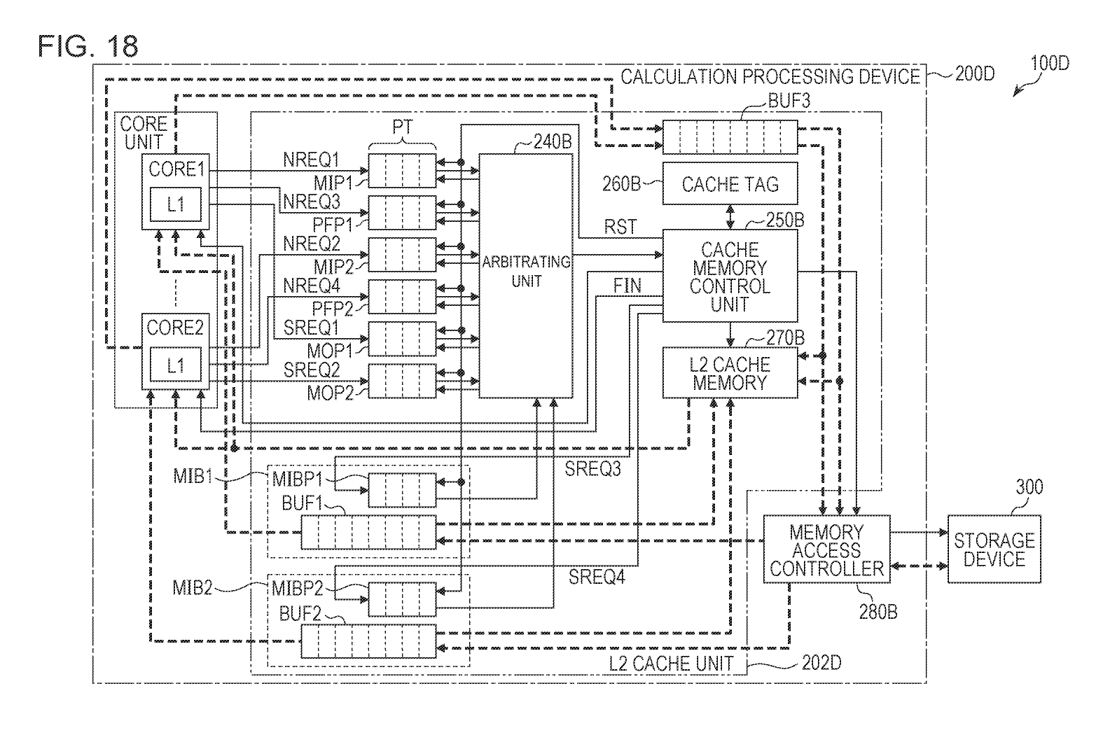

FIG. 18 illustrates an example of an information processing device 100D and a calculation processing device 200D according to another embodiment. Elements that are the same or similar to that of FIG. 5 have the same reference numerals, and so their detailed descriptions are omitted.

According to the present embodiment, the information processing device 100D includes the calculation processing device 200D and the recording device 300. The information processing device 100D may be, for example, a computer device such as a server or a personal computer, and the calculation processing device 200D may be a processor such as a CPU.

According to the present embodiment, the ports MIP1, MIP2, PFP1, PFP2, MOP1, MOP2, MIBP1, and MIBP2 are equivalent to the ports MIP1, MIP2, PFP1, PFP2, MOP1, MOP2, MIBP1, and MIBP2 illustrated in FIG. 5. Other configurations of the information processing device 100D, calculation processing device 200D, and an L2 cache unit 202D are similar to the information processing device 100B, calculation processing device 200B, and an L2 cache unit 202B illustrated in FIG. 5.

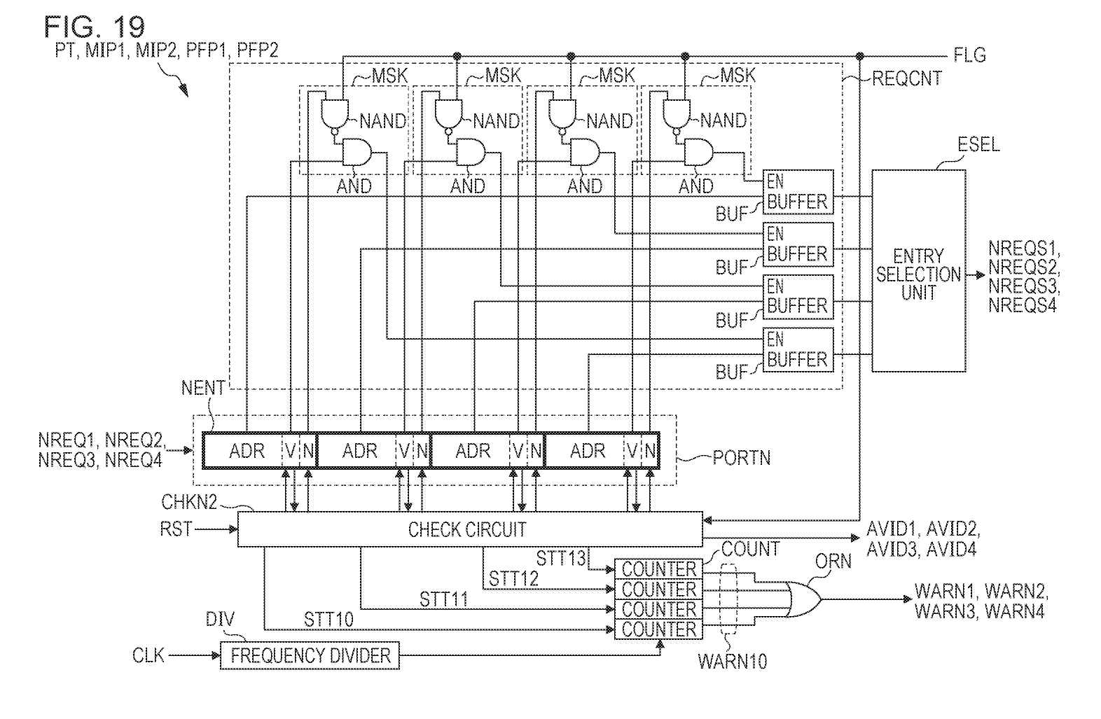

FIG. 19 illustrates examples of the ports MIP1, MIP2, PFP1, and PFP2 illustrated in FIG. 18. Elements that are the same or similar to that of FIG. 6 have the same reference numerals, and so their detailed descriptions are omitted. The ports MIP1, MIP2, PFP1, and PFP2 have the same or similar configurations, and so only the port MIP1 will be described here.

The port MIP1 includes a check circuit CHKN2 in place of the check circuit CHKN illustrated in FIG. 6. Also, the port MIP1 includes four counter COUNT corresponding to each entry NENT and an OR circuit ORN. Each counter COUNT operates by synchronizing with the clock for which the frequency has been divided by the frequency dividing circuit DIV. The frequency dividing circuit DIV and counter COUNT function as a timer. The timer is provisioned corresponding to the units of entry NENT, start counting time in response to the corresponding start signal STT1 (STT10 through STT13), and output a warning notification WARN10 when the predetermined time Tmax elapsed.

That is to say, each counter COUNT outputs the warning notification WARN10 based on the warning notification WARN1 to the OR circuit ORN on the basis that the time the access request NREQ1 has been stored in the corresponding entry NENT has passed the predetermined time Tmax. When the OR circuit ORN receives the warning notification WARN10 from any counter COUNT, the OR circuit ORN outputs the warning notification WARN1 to the arbitrating unit 240B.

The check circuit CHKN2 outputs the start signal STT1 to start the count operation for the corresponding counter COUNT when the flag V for each entry NENT is detected to be set during a period in which the flag signal FLG is at a low level (period of the release notification FRST). Conversely, the check circuit CHKN2 may output the start signal STT1 when the flag V for each entry NENT is detected to be set at a timing when the flag signal FLG changes from a high level to a low level (timing of the output of the release notification FRST).

When the flag V for each entry NENT is reset, the check circuit CHKN2 stops the operation of the corresponding counter COUNT, and resets the counter value. Further, the check circuit CHKN2 outputs the bypass notification AVID1 to the arbitrating unit 240B when the flag V corresponding to all counters COUNT that output the warning notification WARN10 are reset during a period in which the flag signal FLG is at a high level (period of the configuration notification FSET).

In this way, the check circuit CHKN2 outputs the start signal STT1 when the access request NREQ is stored in each entry NENT, and outputs the bypass notification AVID1 when the access request NREQ stored in each entry NENT is processed.

Except for the function to control the counter COUNT, the check circuit CHKN2 has the same functionality as the check circuit CHKN illustrated in FIG. 6. Further, the ports MIP1, MIP2, PFP1, and PFP2 illustrated in FIG. 18 may include the mask circuit MSK illustrated in FIG. 23 in place of the mask circuit MSK illustrated in FIG. 19 for cases in which the flag N is reset during a period in which the flag signal FLG is at a low level. That is to say, each mask circuit MSK may invert the logic of the flag N, and may include an inverter IV, in place of an NAND circuit, for outputting the inverted logic to the input of an AND circuit. In this case, the mask circuit MSK may control the enable terminal EN in the buffer BUF without receiving the flag signal FLG.

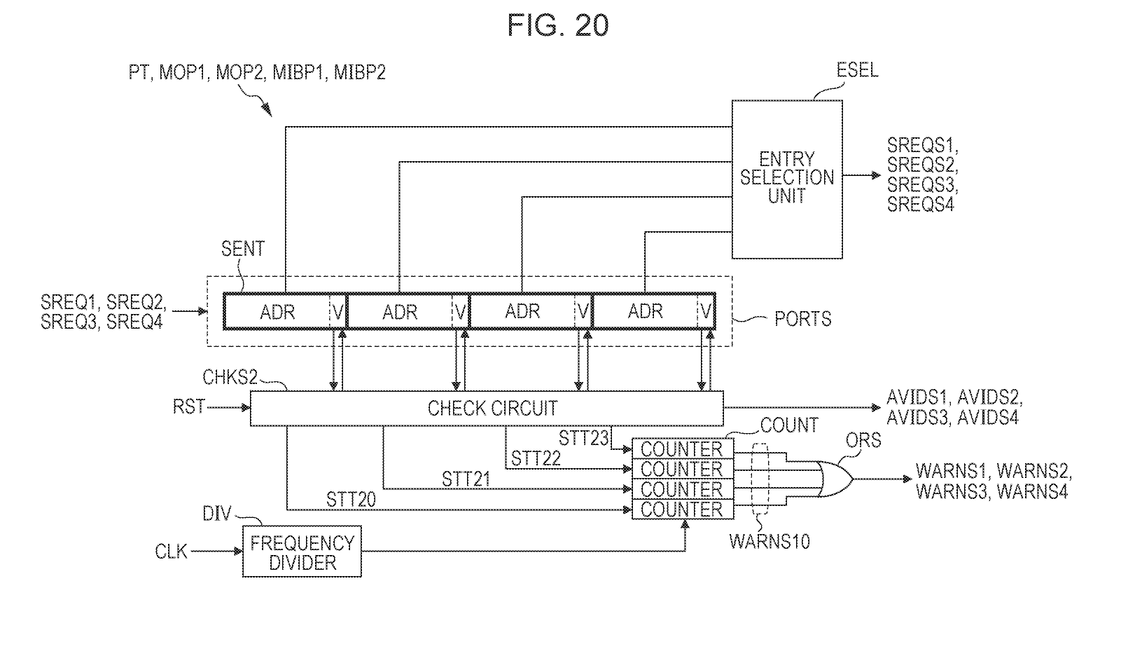

FIG. 20 illustrates examples of the ports MOP1, MOP2, MIBP1, and MIBP2 illustrated in FIG. 18. Elements that are the same or similar to that of FIG. 7 have the same reference numerals, and so their detailed descriptions are omitted. The ports MOP1, MOP2, MIBP1, and MIBP2 have the same or similar configurations, and so the port MIBP1 will be described here.

The port MIBP1 includes a check circuit CHKS2 in place of the check circuit CHKS illustrated in FIG. 7. Also, the port MIBP1 includes four counter COUNT corresponding to each entry SENT and an OR circuit ORS. Each counter COUNT operates by synchronizing with the clock for which the frequency has been divided by the frequency dividing circuit DIV. The frequency dividing circuit DIV and counter COUNT function as a timer. The timer is provisioned corresponding to the units of entry SENT, start counting time in response to the corresponding start signal STT2 (STT20 through STT23), and output a warning notification WARNS10 when the predetermined time Tmax elapsed.

That is to say, each counter COUNT outputs the warning notification WARNS10 based on the warning notification WARNS1 to the OR circuit ORS on the basis that the time the access request SREQ3 has been stored in the corresponding entry SENT has passed the predetermined time Tmax. When the OR circuit ORS receives the signal WARNS10 from any counter COUNT, the OR circuit ORS outputs the warning notification WARNS1 to the arbitrating unit 240B.

The check circuit CHKS2 starts the count operation for the corresponding counter COUNT when the flag V for each entry SENT is detected to be set. When flag V is reset for each entry SENT, the check circuit CHKS2 stops the operation of the corresponding counter COUNT, and resets the counter value. Further, the check circuit CHKS2 outputs the bypass notification AVIDS1 to the arbitrating unit 240B when the flag V corresponding to all counters COUNT that output the warning notification WARNS10 is reset.

In this way, the check circuit CHKS2 outputs the start signal STT2 when the access request SREQ is stored in each entry SENT, and outputs the bypass notification AVIDS1 when the access request SREQ stored in each entry NENT is processed. Except for the function to control the counter COUNT, the check circuit CHKS2 has the same functionality as the check circuit CHKS illustrated in FIG. 7.

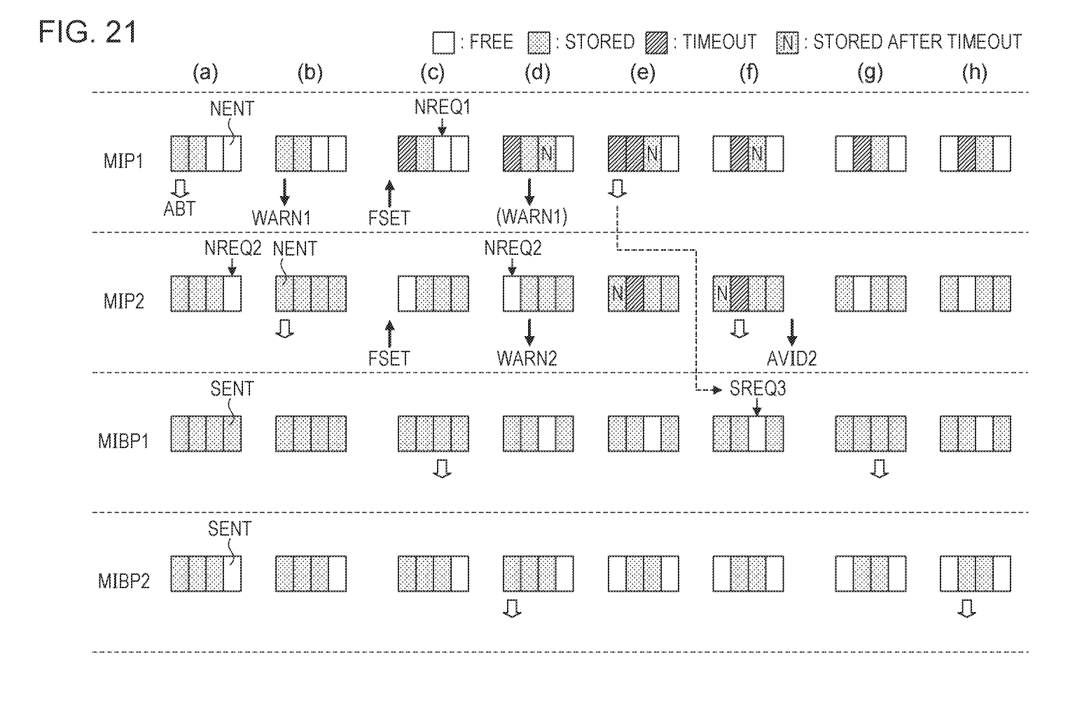

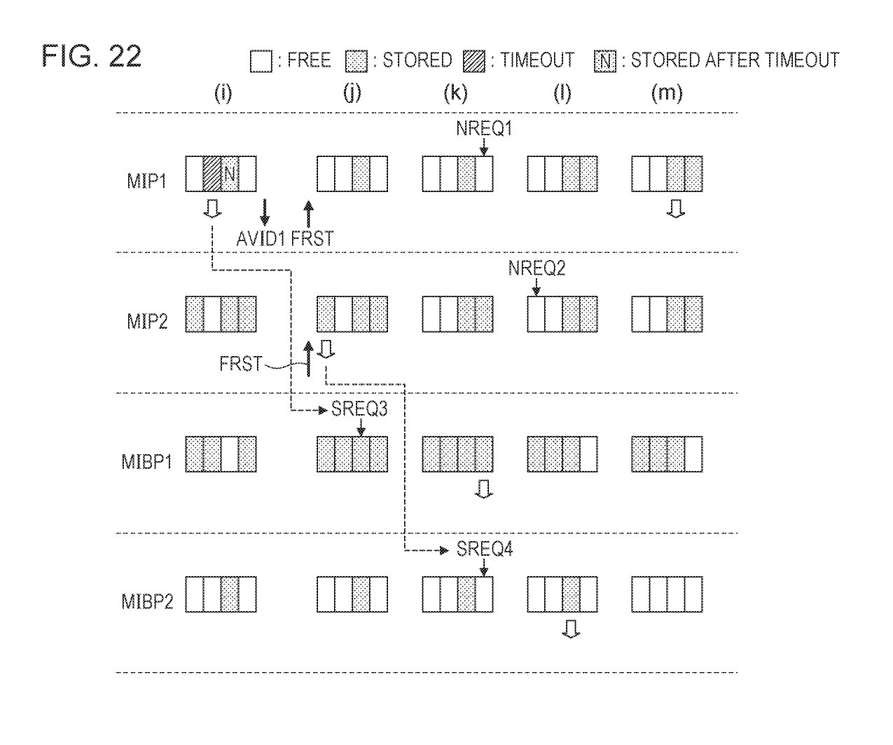

FIG. 21 and FIG. 22 illustrate an example of an operation of the information processing device 100D and the calculation processing device 200D illustrated in FIG. 18. That is to say, FIG. 21 and FIG. 22 illustrate an example of the control method of the information processing device 100D and the calculation processing device 200D. Detailed descriptions of operations that are the same or similar to that of FIG. 14 are omitted. According to the present example and similar to FIG. 14, the calculation processing device 200D includes four ports PT (MIP1, MIP2, MIBP1, and MIBP2).

According to the present embodiment, the check circuit CHKN2 illustrated in FIG. 19 and the check circuit CHKS2 illustrated in FIG. 20 operate the corresponding counter COUNT on the basis of the access request NREQ and SREQ stored in each entry NENT and SENT. For this reason, there is no entry NENT of interest or entry SENT of interest as illustrated by the heavy border in FIG. 14. The operations of the ports MIP2, MIBP1, and MIBP2 are similar to those as in FIG. 14.

Regarding a state (b), one counter COUNT in the port MIP1 outputs the warning notification WARN1 (WARN10) on the basis that the time since the access request NREQ1 has been stored in the corresponding entry NENT has passed the predetermined time Tmax. The arbitrating unit 240B changes the flag signal FLG from a low level to a high level on the basis of the warning notification WARN1 to output the configuration notification FSET.

Afterwards, regarding a state (d), a different counter COUNT in the port MIP1 outputs the warning notification WARN10 on the basis that the time since the access request NREQ1 has been stored in the corresponding entry NENT has passed the predetermined time Tmax. However, as the warning notification WARN1 has been output at the state (b), the warning notification WARN1 remains at a high level, for example.

Next, regarding a state (e), the arbitrating unit 240B reselects the access request NREQ1 stored in the entry NENT of the port MIP1, and outputs this to the cache memory control unit 250B. The cache memory control unit 250B determines a cache miss on the basis of the access request NREQ1, and determines that the access request SREQ3, which is the derived instruction and based on the access request NREQ1, is desirable. As the entry SENT in the port MIBP1 is free at this time, the cache memory control unit 250B outputs the access request SREQ3 to the port MIBP1.

However, according to the present embodiment, the check circuit CHKN2 illustrated in FIG. 19 does not output the bypass notification AVID1 as the warning notification WARN10 is output from the counter COUNT corresponding to the different entry NENT in the port MIP1.

Regarding a state (i) in FIG. 22, the arbitrating unit 240B selects the access request NREQ1 stored in the entry NENT of the port MIP1, and outputs this to the cache memory control unit 250B. The cache memory control unit 250B determines a cache miss on the basis of the access request NREQ1, and determines that the access request SREQ3, which is the derived instruction and based on the access request NREQ1, is desirable. As the entry SENT in the port MIBP1 is free at this time, the cache memory control unit 250B outputs the access request SREQ3 to the port MIBP1.

The check circuit CHKN2 in the port MIP1 outputs the bypass notification AVID1 to the arbitrating unit 240B as the access request NREQ1 stored in each entry NENT longer than the predetermined time Tmax are now gone. The arbitrating unit 240B receives the bypass notification AVID1 corresponding to the warning notification WARN1, and as no other warning notifications WARN are output at this time, the arbitrating unit 240B changes the flag signal FLG from a low level to a high level to output the release notification FRST. The port MIP1 stops the output of the warning notification WARN1 and the bypass notification AVID1 in response to the flag signal FLG at a low level.

Afterwards, from state (j) to state (m), the arbitrating unit 240B sequentially selects the access request NREQ (or SREQ) stored in the ports MIP2, MIBP1, MIBP2, and MIP1.

Thus, according to the present embodiment, each port PT includes a counter COUNT for each entry NENT and SENT. As a result, the processing of the access request NREQ stored after the configuration notification FSET is suppressed until all access requests NREQ stored before the configuration notification FSET are processed. Therefore, the frequency of the occurrence of access request SREQ derived from the access request NREQ when the warning notification WARN (or WARNS) is output may be decreased further in comparison to the embodiments as illustrated in FIG. 5 through FIG. 14. As a result, the access requests SREQ are not likely to accumulate in the entry SENT, and the probability of calculation processing unit 210 hang ups due to older access requests NREQ not being processed may be lowered in comparison with the related art. This in turn enables the suppression of a decrease in the performance of the information processing device 100D and the calculation processing device 200D.

Further, the calculation processing device 200D illustrated in FIG. 18 may include the arbitrating unit 240C illustrated in FIG. 16 in place of the arbitrating unit 240B. In this case, the access requests NREQ and SREQ may be given a priority for selection corresponding to the port PT that output the warning notification WARN and WARNS, which in turn further decreases the probability of core CORE hang ups.

Further, according to the embodiment as illustrated in FIG. 18 through FIG. 22, the example has been described in which each port MIP and PFP include a counter COUNT for each entry NENT, and each port MOP and MIBP2 include a counter COUNT for each entry SENT. However, the units of entry NENT may share a counter COUNT in each port MIP and PFP, and the units of entry SENT may share a counter COUNT in each port MOP and MIBP2.

In this case, the check circuit CHKN in each port MIP and PFP stores the counter value as the time the access request NREQ has been stored in the entry NENT, and determines when each entry NENT has reached the predetermined time Tmax from running amount of the counter value. Similarly, the check circuit CHKS in each port MIOP and MIBP stores the counter value as the time the access request SREQ has been stored in the entry SENT, and determines when each entry SENT has reached the predetermined time Tmax from running amount of the counter value. As a result, the number of counters COUNT may be reduced in comparison to that as in FIG. 19 and FIG. 20 while achieving the same operation as that in FIG. 21 and FIG. 22.

The features and advantages regarding the embodiments have been clarified according to the previous detailed descriptions. The aim of these descriptions serves only to illustrate the features and advantages of the previously described embodiments without departing from the spirit and scope of the claims. One skilled in the art will be capable of readily making various improvement or modifications. The scope of the embodiments having an inventive step is not restricted to the specification previously described, and it should be understood that various changes, substitutions, and alterations could be made hereto within the scope disclosed in the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A calculation processing device coupled with a storage device, the calculation processing device comprising:
a calculation processing unit configured to output requests to the storage device;
a request storage unit including a plurality of request entries configured to store the requests and stopping issuance of a stored request when a first flag is set based on an input configuration notification, in which the request storage unit outputs a warning notification when the request stored in any of the plurality of request entries has not been processed for more than a predetermined amount of time;
a derived request storage unit including a plurality of derived request entries configured to store derived requests derived from processing of requests stored in the request storage unit;
an arbitrating unit configured to arbitrate requests stored in the request storage unit and derived requests stored in the derived request storage unit, and to output the configuration notification based on the warning notification output from the request storage unit; and
a request processing unit configured to process requests or derived requests arbitrated by the arbitrating unit, and to request storage of derived requests derived by processing the requests or the derived requests into the derived storage unit.

2. The calculation processing device according to claim 1,
wherein the request storage unit outputs a bypass notification to the arbitrating unit when the request that has not been processed after the predetermined amount of time has passed is processed by the request processing unit, and releases the set first flag, based on a release notification input from the arbitrating unit, and the arbitrating unit outputs the release notification to the request storage unit when the bypass notification is input.

3. The calculation processing device according to claim 2,
wherein each of the plurality of request entries includes the first flag and further includes a second flag representing storage of a valid request;
and wherein the request storage unit further includes an issuance control unit configured to reset the first flag from reception of the configuration notification until reception of the release notification, issuing the request stored in the request entry for which the second flag is set, stop issuance of the request stored in the request entry for which the first and the second flag is set, and issue the request stored in the request entry for which the second flag is set regardless of a state of the first flag from reception of the release notification until reception of the configuration notification.

4. The calculation processing device according to claim 3,
wherein the request storage unit further includes a flag control circuit configured to set the first flag on the basis that the second flag for the request entry storing a new request is set from reception of the configuration notification until reception of the release notification, and resetting the first flag when the release notification is received.

5. The calculation processing device according to claim 3,
wherein the request storage unit further includes
a first check circuit configured to sequentially select one of the request entries, outputting a first start signal when the request is stored in the selected request entry, and output the bypass notification when the request stored in the selected request entry is processed, and
a first timer configured to start a count of time in response to the first start signal, and output a warning notification when a predetermined amount of time elapses;
and wherein the derived request storage unit further includes
a second check circuit configured to sequentially select one of the derived request entries, output a second start signal when the derived request is stored in the selected derived request entry, and output the bypass notification when the derived request stored in the selected derived request entry is processed,
and a second timer configured to start a count of time in response to the second start signal, and output a warning notification when a predetermined amount of time elapses.

6. The calculation processing device according to claim 3,
wherein the request storage unit further includes
a first check circuit configured to output a first start signal when the request is stored in the request entry, and output the bypass notification when the request stored in the request entry is processed,
and a plurality of first timers provisioned corresponding to each request entry configured to start a count of time in response to the first start signal, and output a warning notification when a predetermined amount of time elapses;
and wherein the derived request storage unit further includes
a second check circuit configured to output a second start signal when the derived request is stored in the derived request entry, and output the bypass notification when the derived request stored in the derived request entry is processed,
and a plurality of second timers provisioned corresponding to each derived request entry configured to start a count of time in response to the second start signal, and output a warning notification when a predetermined amount of time elapses.

7. The calculation processing device according to claim 1, wherein the arbitrating unit gives priority to arbitrating the derived requests issued by the derived request storage unit over the requests issued by the request storage unit.

8. A method of controlling a calculation processing device which is coupled with a storage device, the method comprising:
outputting a request to the storage device by the calculation processing unit;
storing the request output by the calculation processing unit in any of a plurality of request entries;
stopping issuing the stored request when a first flag is set based on an input configuration notification;
outputting a warning notification when the request stored in any of the plurality of request entries has not been processed after a predetermined amount of time has elapsed;
storing a derived request, in which any of derived request entries stores a derived request derived by processing a request stored in the request storage unit;
arbitrating the request stored in the request storage unit and the derived request stored in the derived request storage unit;
outputting the configuration notification, based on a warning notification output by the request storage unit;
processing a request which the arbitrating unit has arbitrated or a derived request; and
storing a derived request derived by processing of the request or the derived request in the derived request storage unit.
